(19) United States
(12) Patent Application Publication
(10) Pub. No.: US 2026/0074449 A1
(43) Pub. Date: Mar. 12, 2026

(54) CONNECTOR AND CONNECTOR ASSEMBLY INCLUDING THE SAME

(71) Applicant: LS MTRON LTD., Anyang-si (KR)

(72) Inventors: Lyung Koo LEE, Anyang-si (KR); Sang Jun OH, Anyang-si (KR)

(21) Appl. No.: 19/265,242

(22) Filed: Jul. 10, 2025

(30) Foreign Application Priority Data
Sep. 12, 2024 (KR) 10-2024-0124765
Sep. 12, 2024 (KR) 10-2024-0124766
Jan. 14, 2025 (KR) 10-2025-0005283
Jan. 14, 2025 (KR) 10-2025-0005284

(51) Int. Cl. H01R 12/70; H01R 12/71; H01R 13/405

(52) U.S. Cl. CPC H01R 12/707; H01R 12/716; H01R 13/405

(57) ABSTRACT

A connector and a connector assembly including the same are disclosed. The connector and the connector assembly including the same according to an aspect of the present disclosure is configured such that an interior solder overflow preventer of the connector may be accommodated in a displacement space of a counterpart connector.

### CROSS-REFERENCE TO RELATED APPLICATION

This application claims priority to and the benefit of Korean Patent Application No. 10-2024-0124765, filed Sep. 12, 2024, Korean Patent Application No. 10-2024-0124766, filed Sep. 12, 2024, Korean Patent Application No. 10-2025-0005283, filed Jan. 14, 2025, and Korean Patent Application No. 10-2025-0005284, filed Jan. 14, 2025, the disclosures of which are incorporated herein by reference in its entirety.

### FIELD

The present disclosure relates to a connector, and more particularly, to a connector configured to be mounted on a substrate and a connector assembly including the same.

### BACKGROUND

In general, a connector assembly is installed in electronic devices such as mobile phones, computers, and tablet computers to electrically connect various components installed in the electronic devices to each other.

Meanwhile, the connector assembly for a substrate is used to connect printed circuit boards (PCBs) or electronic components with patterned conductive wires. In particular, the B2B connector (board to board connector) assembly includes a plug connector and a receptacle connector, and each of which is connected to different module substrates.

And, the plug connector and the receptacle connector may be named a first connector and a second connector, and the plug connector and the receptacle connector are coupled to enable transmission of signals through different boards.

On the other hand, the plug connector includes a plurality of plug contacts spaced apart from each other in the longitudinal direction, and the receptacle connector includes a receptacle contact spaced apart from each other in the longitudinal direction to correspond to the plug contacts.

And, while plug connector and the receptacle connector are coupled with each other, the plug contacts and the receptacle contacts are in contact with each other to form a connection state between the module substrates equipped with the B2B connector.

On the other hand, the size of the module substrate is gradually seeking to be smaller. Accordingly, the plug connector and the receptacle connector constituting the B2B connector assembly may also need to be miniaturized (low height) while having a plurality of contacts.

However, when the number of contacts increases, the length of the plug connector and the receptacle connector will be long, and when it becomes excessively longer, cold soldering may occur due to poor insert molding injection filling and flatness problems caused by warpage of the connector product. Furthermore, when the length of the plug connector and the receptacle connector becomes longer, problems in miniaturization are bound to occur.

As a result, two pairs of plug connectors and receptacle connectors of the B2B connector assembly may be used instead of one pair, but when two or more pairs are used, the number of workers engaged in fastening work connecting them to a substrate must increase by two or more times.

On the other hand, to miniaturize the B2B connector assembly, the length of the long direction (longitudinal direction, first direction of the X-axis), the width of the short direction (width direction, second direction of the Y axis) and the thickness of the height direction (third direction of the Z-axis) of the plug connector and the receptacle connector must be reduced as much as possible.

However, as the length of the connector in the first direction and the width in the second direction decrease, the gap between the contacts also decreases, and accordingly, the difficulty of the soldering work to couple the contacts with the module substrate increases, and there is a concern that the soldering portions of each contact may come into contact with each other, causing electrical interference.

In addition, there are many restrictions on miniaturizing the size of the connector, such as the occurrence of warpage of the connector product and the occurrence of a solder overflow phenomenon that causes the soldered solder to burn and rise and cause defects as the thickness (height) in the third direction decreases.

Therefore, there is a need for a connector capable of being miniaturized and improving manufacturing convenience and contact reliability, and a connector assembly including the same.

### PRIOR ART DOCUMENT

### Patent Document

Korean Patent Laid-Open Publication No. 10-2019-0027133 (published on Mar. 14, 2019)

### SUMMARY

The present disclosure is to solve the above problems, and it is an object of the present disclosure to provide a connector and a connector assembly including the same. which can be miniaturized while improving manufacturing convenience and contact reliability through a change in the structure of the connector.

The present disclosure is also to provide a connector and a connector assembly including the same, which can maintain contact reliability between contacts in an ultra-narrow pitch structure.

The present disclosure is also to provide a connector and a connector assembly including the same, which can prevent solder overflow and maintain contact fixation by maintaining an insulator thickness (height) of an important portion while achieving miniaturization.

The present disclosure is also to provide a connector and a connector assembly including the same, which can realize miniaturization by minimizing the increase in the size of a product while including a hold-down for strength reinforcement

The technical problems of the present disclosure are not limited to the above-mentioned problems, and other technical problems not mentioned may be clearly understood by those skilled in the art to which the present disclosure belongs from the following description.

According to an aspect of the present disclosure, a first connector 100 is provided.

The first connector 100 may be coupled with a second connector 200 to form a connector assembly 1.

The first connector 100 may include a first connector insulator 110 including a bottom 111 of a flat plate shape, a pair of holding walls 114 and 115 configured to protrude from the bottom 111 and extend in parallel to each other along a first direction, and an island 112 configured to protrude from the bottom 111 and extend in parallel between the pair of the holding walls 114 and 115; a plurality of first contacts 120 configured to be at least partially exposed to outside the first connector insulator 110 and be spaced apart from each other along the first direction on each of the holding walls 114 and 115; and a plurality of second contacts 130 configured to be at least partially exposed to the outside and be spaced apart alternately from the first contacts 120 on each of the holding walls 114 and 115.

In this case, each of the first contacts 120 may be configured such that it is a shape of a bent bar having a length in a second direction and supported while wrapping around the holding wall 114 or 115, and include an interior mounting section 123 configured to be bent along the bottom 111 toward the island 112 and be exposed to a lower surface of the bottom 111 and is mounted on a substrate while an interior side forming an interior molding space S/I upward in the second direction.

In this case, the first connector insulator 110 may include a solder overflow preventer 117 configured such that it has a stepped height t1 protruding from an upper surface of the bottom 111 in the interior molding space S/I in a third direction.

According to another aspect of the present disclosure, the second connector 200 may be provided.

The second connector 200 may be coupled with a first connector 100 to form a connector assembly 1.

The second connector 200 may include a second connector insulator 210 including a bottom 211 of a flat plate shape, a pair of exterior holding walls 214 and 215 configured to protrude from the bottom 211 and extend in parallel to each other along a first direction, and a pair of interior holding walls 212a and 212b configured to protrude from the bottom 211 and extend in parallel to each other between the pair of exterior holding walls 214 and 215 to form an island accommodating space 203; a plurality of first contacts 220 configured to be at least partially exposed to outside the second connector insulator 210 and be spaced apart from each other along the first direction on each of the exterior holding walls 214 and 215 and the interior holding walls 212a and 212b; and a plurality of second contacts 230 configured to be at least partially exposed to the outside and be spaced apart alternately from the first contacts 220 on each of the exterior holding walls 214 and 215 and the interior holding walls 212a and 212b.

In this case, each of the first contacts 220 may be configured such that it is a shape of a bent bar having a length in a second direction and supported while wrapping around the exterior holding wall 214 or 215, the bottom 211, and the interior holding wall 212a or 212b, and include an interior mounting section 223 configured to be bent toward the island accommodating space 203 and be exposed to a lower surface of the bottom 211 and is mounted on a substrate while an interior side wraping around the interior holding wall 212a or 212b forming an interior molding space S/I upward in the second direction.

In this case, the second connector insulator 210 may include an interior solder overflow preventer 217 configured such that it has a stepped height t1′ protruding from an upper surface of the bottom 211 in the interior molding space S/I in a third direction.

According to yet another aspect of the present disclosure, a first connector 100 and a second connector 200 may be coupled with each other to provide a connector assembly 1 having a length in a first direction, a width in a second direction, and a thickness (height) in a third direction.

In this case, the first connector 100 may include a first connector insulator 110 including a pair of holding walls 114 and 115 configured to protrude from a bottom 111 of a flat plate and have a length and height, an island 112 configured to protrude from the bottom 111 and have a length and a height between the holding walls 114 and 115, and a first coupling space 101 and a second coupling space 102 in which interior holding walls 212a and 212b of the second connector 200 is accommodated between the island 112 and the holding walls 114 and 115; and a first contact 120 and a second contact 130 configured to be alternately spaced apart from each other along the first direction on each of the holding walls 114 and 115 in a bar shape having a length in the second direction.

In this case, the second connector 200 may include a second connector insulator 210 including a pair of exterior holding walls 214 and 215 configured to protrude from a bottom 211 of a flat plate and have a length and height, a pair of interior holding walls 212a and 212b configured to protrude with a length and a height between the exterior holding walls 214 and 215 while forming an island accommodating space 203 in which the island 112 of the first connector 100 is received, and a first accommodating space 201 and a second accommodating space 202 in which the holding walls 114 and 115 of the first connector 100 are received between the interior holding walls 212a and 212b and the exterior holding walls 214 and 215, and a first contact 220 and a second contact 230 configured to be alternately spaced apart from each other along the first direction on each of the exterior holding walls 214 and 215, and interior holding walls 212a and 212b in a bar shape having a length in the second direction.

In this case, the first connector insulator 110 may have an interior solder overflow preventer 117 configured to protrude with a step height t1 from the bottom 111 on an upper portion of the first contact 120 disposed in the first coupling space 101 and the second coupling space 102.

In this case, the second connector insulator 210 may have a groove or hole-shaped displacement space S1′ in which the second contact 230 disposed on the interior holding wall 212a or 212b is elastically deformable.

In this case, when the first connector 100 and the second connector 200 may be coupled with each other, the interior solder overflow preventer 117 of the first connector 100 is accommodated within the displacement space S1′ of the second connector 200.

According to the configuration, the connector and the connector assembly including the same according to the present disclosure can be implemented in a zigzag manner as the first contacts and the second contacts having different shapes are alternately arranged in the length of the first direction of the connectors, and thus the gap between the contacts can be minimized (ultra-narrow pitch), so that the connector assembly can be reduced in the length of the long direction (first direction of the X-axis) to be small.

In addition, the connector and the connector assembly including the same according to the present disclosure can be smaller because the displacement space of the first connector is arranged in a zigzag manner along the first direction, and thus the width of the connector in the short direction (second direction of the Y-axis) can be reduced.

In addition, the elastic contacting sections of the contact can have a structure having elastic deformation in the displacement spaces, and thus the fracture or detachment of the position due to the external force during the coupling process of the first connector and the second connector can be prevented, thereby leading to a more stable coupling.

In addition, the interior solder overflow preventer of the first connector can have a step height t1 accommodated in the displacement space of the second connector, and the interior solder overflow preventer of the second connector can have a step height t1′ accommodated in the displacement space of the first connector, thereby reducing the height in the third direction (thickness), thereby realizing a thinner thickness and smaller size of the entire product.

In addition, since the plurality of interior solder overflow preventers having such a concavo-convex shape are accommodated in a manner of interlocking like gear teeth in a plurality of displacement spaces of the counterpart connector, when an external force is generated, the pitch direction flow is prevented, so it is easy to maintain contact alignment. and it is of course possible to prevent contact from being twisted or detached even if the external force is generated.

In addition, the connector hold-down has a structure protecting both sides of the insulator and protecting the island end of the island, so that the physical stability and the contact stability can be increased while having strong rigidity against an external force.

In addition, since the island protecting section of the first connector hold-down can be biased to one side in the second direction based on the longitudinal virtual centerline while protecting the island end, the length of the first connector can be further reduced, and the second connector 200, which is the counterpart connector, can also be reduced to a corresponding size, so that the length of the retire connector assembly in the long direction (longitudinal direction, first direction of the X-axis) can be further reduced, thereby realizing miniaturization.

The effect of the present disclosure is not limited to the above effects, and it should be understood that all effects can be inferred from the detailed description of the present disclosure or the claims of the disclosure.

### BRIEF DESCRIPTION OF THE DRAWINGS

FIG. 1 is a perspective view showing a connector assembly according to an embodiment of the present disclosure.

FIG. 2 is a view showing the connector assembly according to the embodiment of the present disclosure from above.

FIG. 3 is a view showing the connector assembly according to the embodiment of the present disclosure, viewed from below.

FIG. 4 is a view showing a state in which a first connector and a second connector constituting the connector assembly according to the embodiment of the present disclosure are separated.

FIG. 5 is a perspective view showing a first connector according to an embodiment of the present disclosure.

FIG. 6 is an exploded perspective view showing the first connector according to the embodiment of the present disclosure.

FIG. 7A is a view showing the first connector according to the embodiment of the present disclosure from above.

FIG. 7B is a view enlarging a portion “A” in the first connector of FIG. 7A.

FIG. 8 is a view showing the first connector according to the embodiment of the present disclosure, viewed from below.

FIG. 9 is a view showing a first contact applied to the first connector according to an embodiment of the present disclosure.

FIG. 10 is a view showing a second contact applied to the first connector according to an embodiment of the present disclosure.

FIGS. 11 to 14 are views showing a first connector hold-down applied to the first connector according to an embodiment of the present disclosure.

FIG. 15 is a cross-sectional view of the first connector of FIG. 7A in the I-I direction.

FIG. 16 is a cross-sectional view of the first connector in FIG. 7A in the II-II direction.

FIG. 17 is a cross-sectional view of the first connector of FIG. 7A in the III-III direction.

FIG. 18A is a view enlarging a portion “B” in the first connector of FIG. 17.

FIG. 18B is a perspective view enlarging a portion “B” in the first connector of FIG. 17.

FIG. 19 is a perspective view showing a second connector according to an embodiment of the present disclosure.

FIG. 20 is an exploded perspective view showing the second connector according to the embodiment of the present disclosure.

FIG. 21A is a view showing the second connector according to the embodiment of the present disclosure from above.

FIG. 21B is a view enlarging a portion “C” in the second connector of FIG. 21A.

FIG. 22 is a view showing the second connector according to the embodiment of the present disclosure from below.

FIG. 23 is a view showing a first contact applied to the second connector according to an embodiment of the present disclosure.

FIG. 24 is a view showing a second contact applied to the second connector according to an embodiment of the present disclosure.

FIGS. 25 and 26 are views showing a second connector hold-down applied to the second connector according to an embodiment of the present disclosure.

FIG. 27 is a cross-sectional view of the second connector of FIG. 21A in the IV-IV direction.

FIG. 28 is a cross-sectional view of the second connector of FIG. 21A in the V-V direction.

FIG. 29 is a perspective view enlarging a portion “C” after forming a cross-section in the VI-VI direction in the second connector of FIG. 21A.

FIG. 30 is a view showing a cross-section in the VII-VII direction in the connector assembly of FIG. 1.

FIG. 31 is a view showing a cross-section in the VIII-VIII direction in the connector assembly of FIG. 1.

FIG. 32A is a view enlarging a portion “D” in the connector assembly of FIG. 31.

FIG. 32B is a view enlarging a portion “E” in the connector assembly of FIG. 31.

FIG. 33 is a view enlarging a portion “F” after forming a cross-section in the IX-IX direction in the connector assembly of FIG. 1.

FIG. 34 is a schematic view for explaining that in the connector assembly according to an embodiment of the present disclosure, the interior solder overflow preventer formed in the first connector and the second connector is accommodated in the displacement space of the counterpart connector, and separation can be prevented when an external force occurs.

FIG. 35 is a view showing a state in which the first connector constituting the connector assembly according to an embodiment of the present disclosure is mounted on a first connector substrate pattern.

FIG. 36 is a view showing a state in which the second connector constituting the connector assembly according to an embodiment of the present disclosure is mounted on a second connector substrate pattern.

### DETAILED DESCRIPTION

Hereinafter, embodiments of the present disclosure will be described in detail with reference to the accompanying drawings so that the person skilled in the technical field to which the present disclosure belongs can easily perform.

In the description of the present disclosure, the fact that a component is “forward,” “rear,” “upper,” or “lower” of another component includes not only being placed “forward,” “rear,” “upper.” or “lower,” but also being placed in the middle of another component, unless there are special circumstances. In addition, it is not only that a component is “connected” to another component, unless otherwise specified, not only that the component is directly connected to each other, but also that the component is indirectly connected to each other.

The terms “X-axis”, “Y-axis”, and “Z-axis” used in the description will be understood by referring to the coordinate system shown in the drawings. In addition, in the description, the X-axis direction is referred to as a first direction, the Y-axis direction is referred to as a second direction, and the Z-axis direction is referred to as a third direction, but this is merely an example based on a relative point of view, and the first to third directions and the coordinate axes (x, y, z) are introduced to describe relative positions between the components, and the absolute positions of each component are not limited.

In addition, in the description of the present disclosure, a first connector and a second connector are merely named by a relative point of view in the connector assembly for ease of description, and are not limited to the absolute name, and may be referred to opposite to each other.

In addition, in the description of the present disclosure, a detailed description of related known functions or configurations will be omitted so as not to obscure the gist of the present disclosure.

Hereinafter, a connector and a connector assembly including the same according to an embodiment of the present disclosure will be described with reference to the drawings.

### —Connector Assembly—

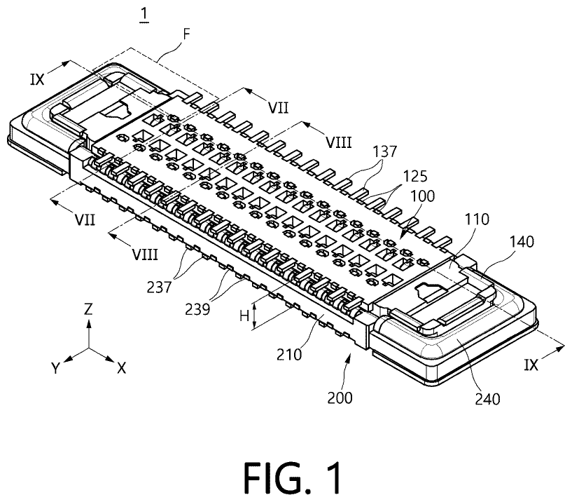

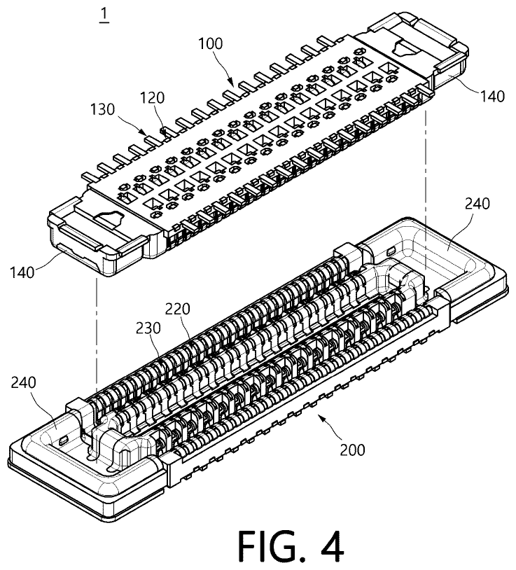

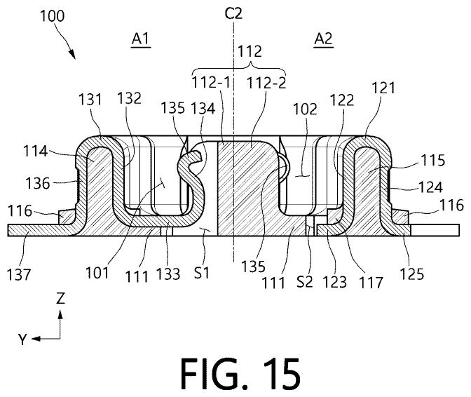

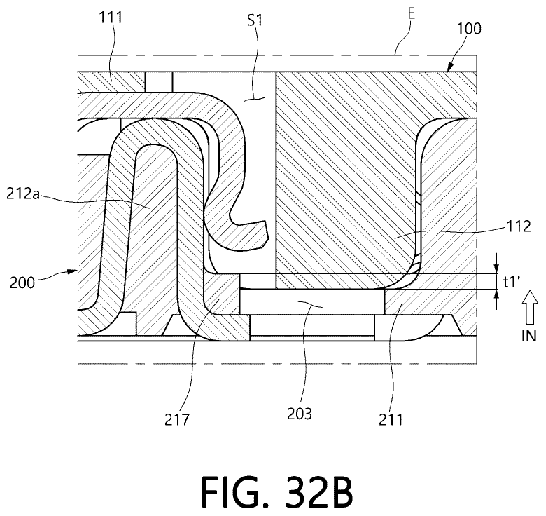

First, referring to FIGS. 1 to 36, the connector assembly 1 according to an embodiment of the present disclosure may be a B2B connector that is physically coupled with each other to electrically connect two different substrates.

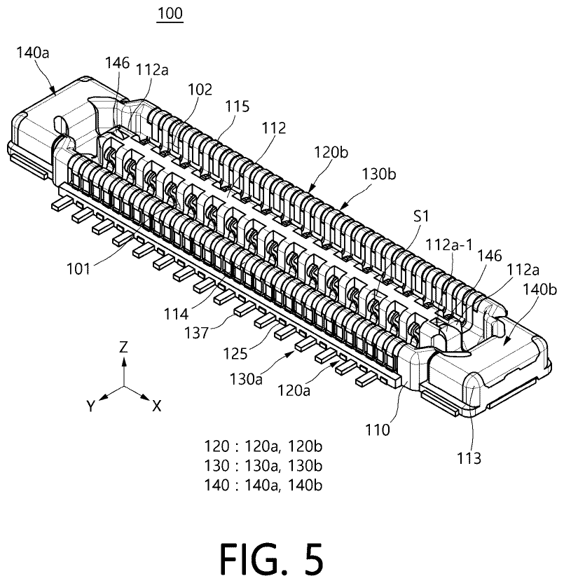

That is, the connector assembly 1 according to an embodiment of the present disclosure may include a first connector 100 as a plug connector and a second connector 200 as a receptacle connector, which are physically coupled with each other, as shown in FIGS. 1 and 4.

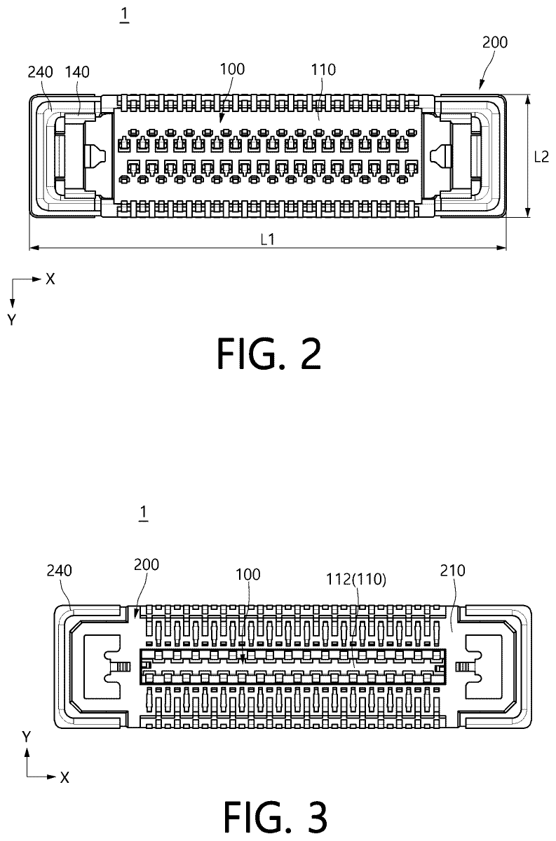

The connector assembly 1 may have a length S1 (FIG. 2) in a first direction and a width S1 (FIG. 2) in a second direction and a thickness (height) H (FIG. 1) in a third direction by coupling the first connector 100 and the second connector 200.

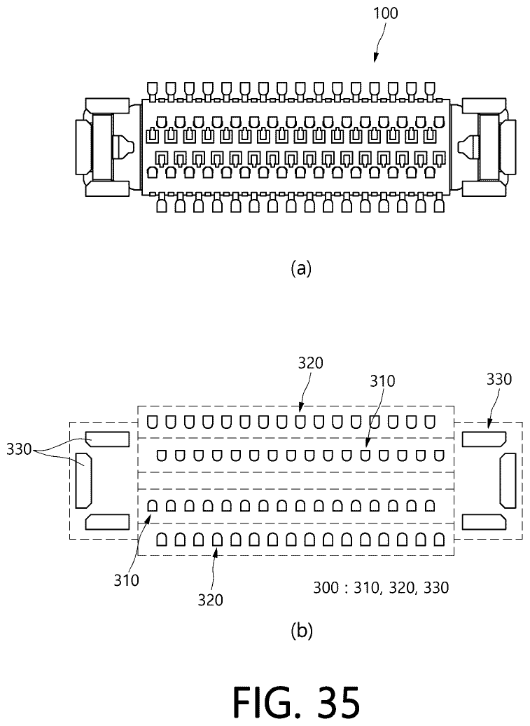

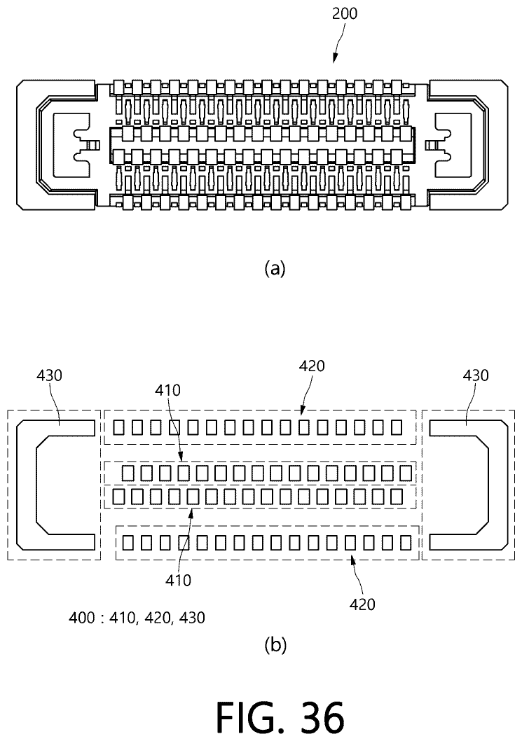

In this case, the first connector 100 may be mounted on any module substrate (not shown) through the first connector BCP pattern 300 (FIG. 35), and the second connector 200 may be mounted on another module substrate (not shown) through the second connector PCB pattern 400 (FIG. 36).

In addition, when the first connector 100 and the second connector 200 are physically coupled to configure the connector assembly 1, the first contact 120 and the second contact 130 provided in the first connector 100 may be in contact with the first contact 220 and the second contact 230 provided in the second connector 200, and accordingly a module substrate with the first connector 100 mounted and a module substrate with the second connector 200 mounted may be electrically connected to each other.

In addition, the first connector 100 and the second connector 200 may include first connector hold-downs 140: 140a and 140b and second connector hold-downs 240: 240a and 240b, respectively, to enable strength reinforcement and high current transmission.

When the first connector 100 and the second connector 200 are physically coupled with each other, the first connector hold-downs 140 and the second connector hold-downs 240 may reinforce the strength of the connectors 100 and 200 by preventing damage caused by physical contact between them with a metal material, and may also be used as a power terminal (a terminal for high current) when the first connector 100 and the second connector 200 are physically coupled with each other to form a connector assembly 1.

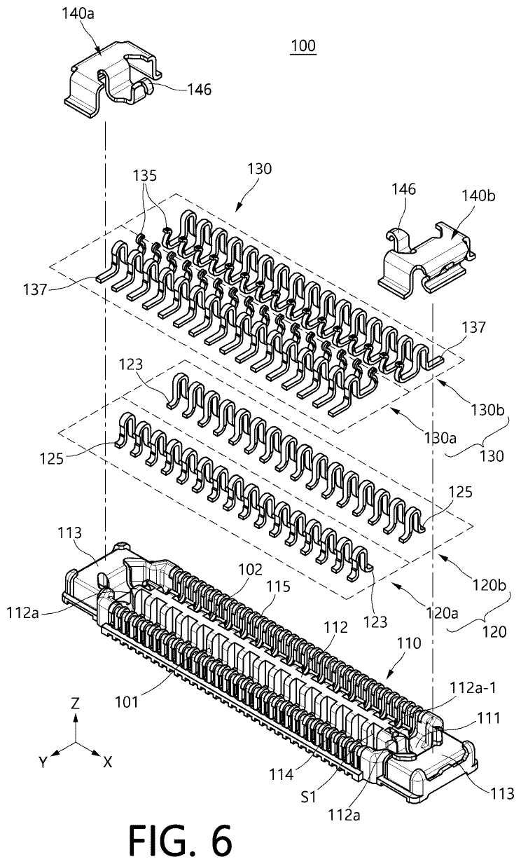

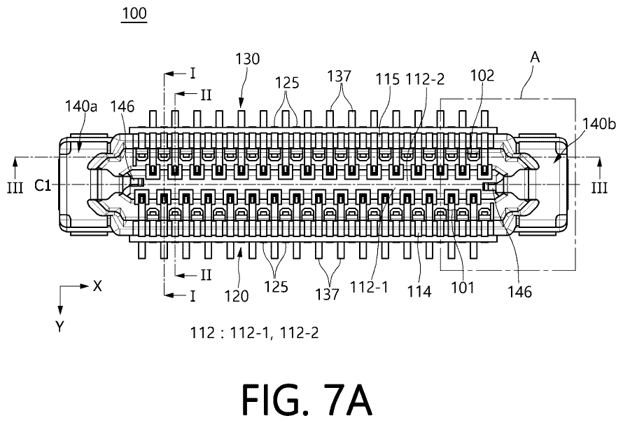

Meanwhile, each of the first connector hold-downs 140: 140a and 140b (FIG. 5) of the first connector 100 is disposed in a shape that wraps around the hold-down holding wall 113 (FIG. 6) on both sides in the first direction while simultaneously wrapping around two island ends 112a of the island 112, and may be mounted on the first connector hold-down pattern 330 of the first connector PCB pattern 300 (FIG. 35) and fixed to the substrate, and may be used as a reinforcing force and a power terminal (a terminal for high current).

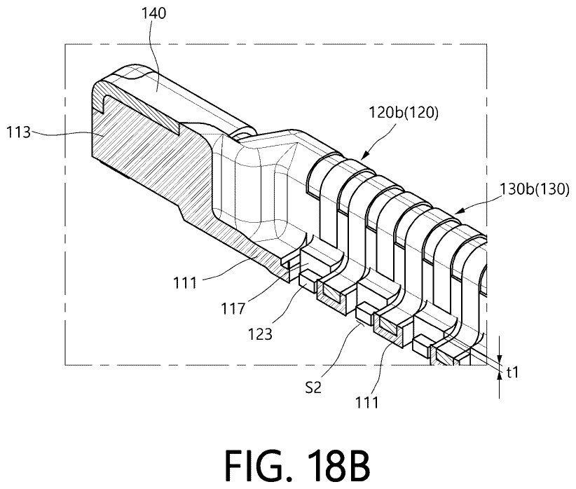

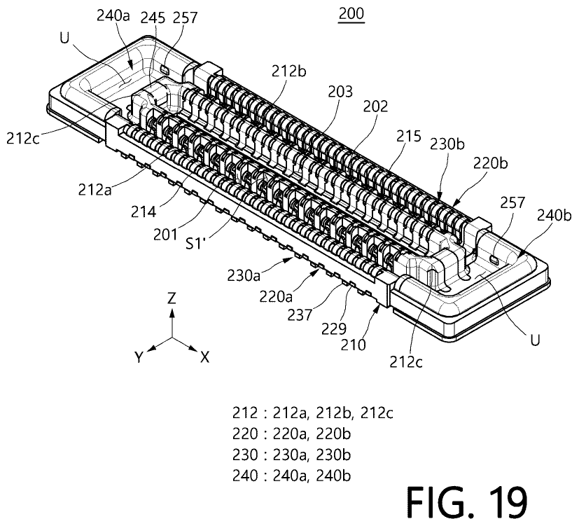

And, each of the second connector hold-downs 240: 240a and 240b (FIG. 19) of the second connector 200 is disposed in a shape that wraps around the hold-down holding walls 213 (FIG. 20) on both sides in the first direction while simultaneously wrapping around the connecting wall 212c (FIG. 20) connecting the interior holding walls 212a and 212b and has an accommodating groove U so as to be able to receive the first connector hold-down 140 described above, and may be mounted on the second connector hold-down pattern 430 of the second connector PCB pattern 400 (FIG. 36) and fixed to the substrate, and may be used as a reinforcing force and a power terminal (a terminal for high current).

Of course, the first connector hold-down 140 and the second connector hold-down 240 may be used as general signal transmission terminals as needed.

Meanwhile, the connectors 100 and 200 and the connector assembly 1 including the same according to an embodiment of the present disclosure may be miniaturized (low height) to facilitate installation in a limited space of a highly integrated electronic device, have strong coupling force, and prevent separation between the connectors 100 and 200.

To this end, the first contact 120 and the second contact 130 of the first connector 100 have a length in the second direction as a shape of a bent bar and are disposed along the length in the first direction of the first connector 100, and have a structure in which they are arranged alternately spaced apart from each other.

Accordingly, first contact PCB patterns 310 of the first connector (FIG. 35) and second contact PCB patterns 320 of the first connector (FIG. 35), which are soldered while forming a structure of an ultra-narrow pitch capable of minimizing a gap between the contacts 120 and 130, have a spaced arrangement structure that prevents interference and reduces short risk and soldering defects.

In addition, the first contact 220 and the second contact 230 of the second connector 200 have a length in the second direction as a shape of a bent bar and are disposed along the length in the first direction of the second connector 200, and have a structure in which they are arranged alternately spaced apart from each other.

Accordingly, first contact PCB patterns 410 (FIG. 36) of the second connector and second contact PCB patterns 420 (FIG. 36) of the second connector, which are soldered while forming a structure of an ultra-narrow pitch capable of minimizing a gap between the contacts 220 and 230, have a spaced arrangement structure that prevents interference and reduces short risk and soldering defects.

As described above, as the first contacts 120 and 220 and the second contacts 130 and 230 are alternately spaced apart from each other and alternately disposed in the first connector 100 and the second connector 200, the gap between the contacts may be minimized (ultra-narrow pitch), so that the length of the entire connectors 100 and 200 in the long direction (longitudinal direction, first direction of the X-axis) may be reduced to enable miniaturization.

As will be described in more detail below, the second contacts 130 and 230 of the first connector 100 and the second connector 200 may include elastic contacting sections 135 and 235 to reinforce the contact and coupling force. In addition, the first connector 100 and the second connector 200 may include displacement spaces S1 and S1′ in the island 112 and the interior holding walls 212a and 212b, respectively, so that the elastic contacting sections 135 and 235 may be stably elastically deformed by an external force when coupled.

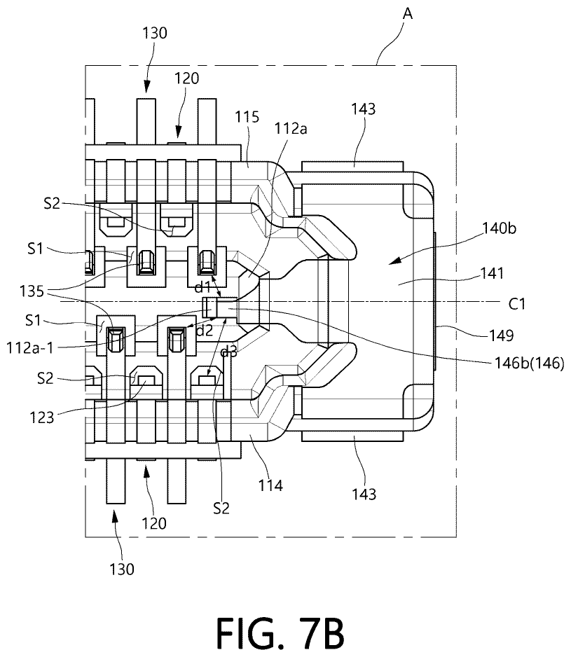

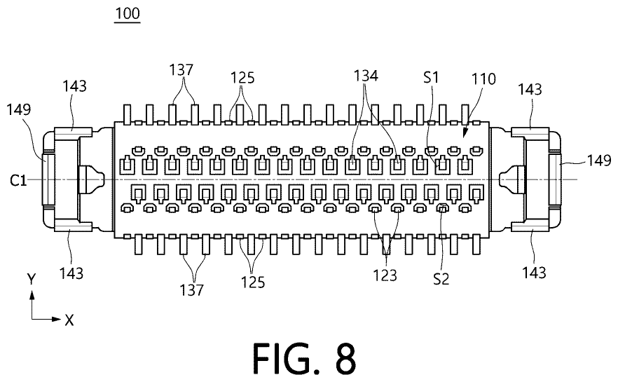

At this time, since the first connector 100 has a plurality of first contacts 120 and second contacts 130 arranged alternately, the displacement space S1 of the first connector 100 is located on a different line from the neighboring displacement space S1 in the second direction and is arranged in a zigzag manner in the first direction (refer to FIGS. 7A and 7B).

As a result, the width of the first connector 100 in the short direction (width direction, second direction of the Y-axis) may be further reduced, so that miniaturization can be possible. In addition, the second connector 200 coupled with the first connector 100 may also be further miniaturized by reducing the width in the second direction to a size corresponding to the first connector 100 described above.

Meanwhile, according to an embodiment of the present disclosure, the first connector 100 and the second connector 200 constituting the connector assembly 1 may further implement thin-plate by reducing the height (thickness) in the third direction to implement further thinning, thereby implementing miniaturization of the entire product.

At this time, when the first connector 100 and the second connector 200 are coupled with each other, the contacts 120, 130, 220 and 230 that perform electric signal transmission and power transmission through mutual contact may be limited in size and size of the contact portion, making it difficult to reduce the height (thickness) in the third direction.

As a result, the thickness of a bottom 111 of the first connector insulator 110 and a bottom 211 of the second connector insulator 210 may be minimized.

However, when the thickness (the height) of the bottom 111 of the first connector 100 and the bottom 211 of the second connector 200 is reduced unconditionally to be thinning, the bottoms 111 and 211 may become too thin to cause warpage of the connector, and the fixing force of the contact may be weak to cause contact instability, and the connectors may be damaged, such as a fracture when the connectors are coupled with each other.

In addition, when the first contact 120 and 220 and the second contact 130 and 230 are mounted on respective substrate, in order to prevent the solder overflow phenomenon in which the soldered solder rises and causes defects, solder overflow preventers 116, 117, 216 and 217 of a predetermined thickness must be formed on the upper portion of mounting sections 123, 137, 223 and 237 of the contacts. In addition, when the first contacts 120 and 220 and the second contacts 130 and 230 are coupled with each other, a predetermined thickness must be ensured to protect the mounting sections 123, 137, 223 and 237, in order not to deviate from the alignment position in the event of an external force due to collision, that is, to prevent detachment. That is, it is necessary to maintain the thickness of the insulator of the important portion to fix and mount the connectors 100 and 200 on the substrate to some extent.

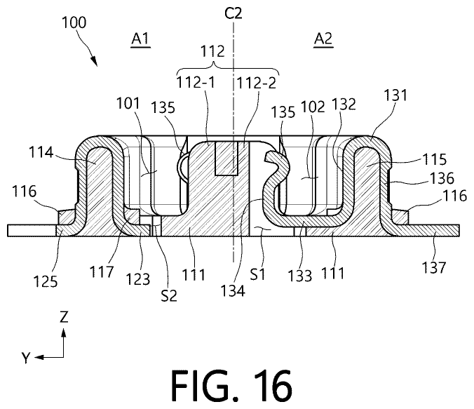

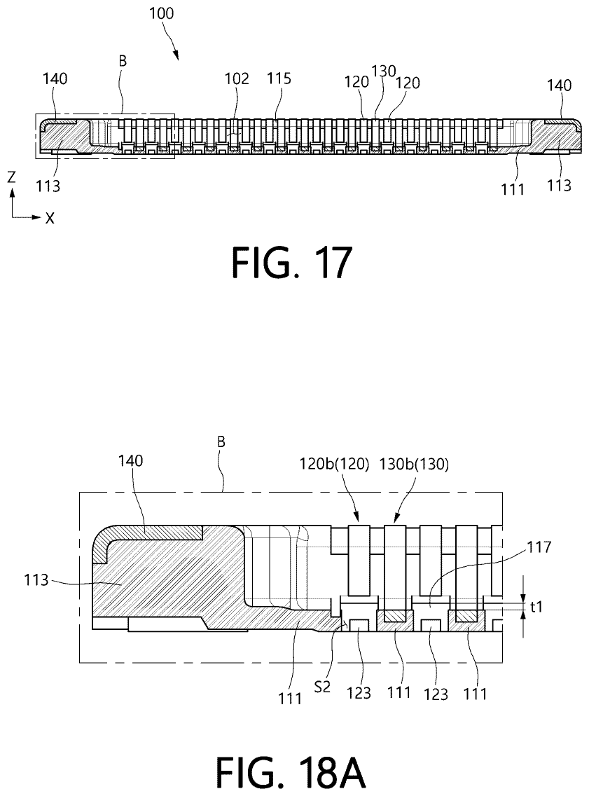

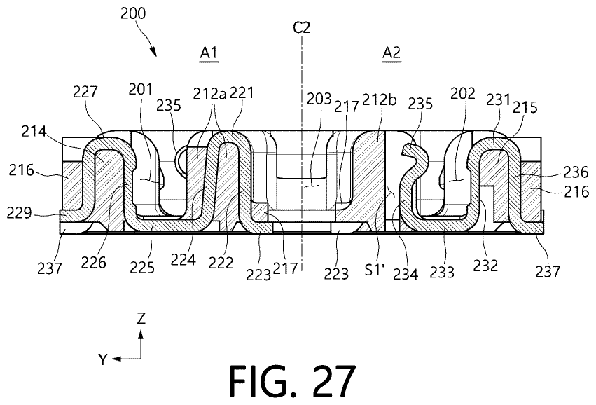

Accordingly, according to an embodiment of the present disclosure, the first connector 100 constituting the connector assembly 1 may form an interior solder overflow preventer 117 having a step height t1 from the bottom 111 while minimizing the thickness of the bottom 111 (refer to FIG. 18B), and the second connector may form an interior overflow preventer 217 having a step height t1′ from the bottom 211 while minimizing the thickness of the bottom 211 (refer to FIG. 29).

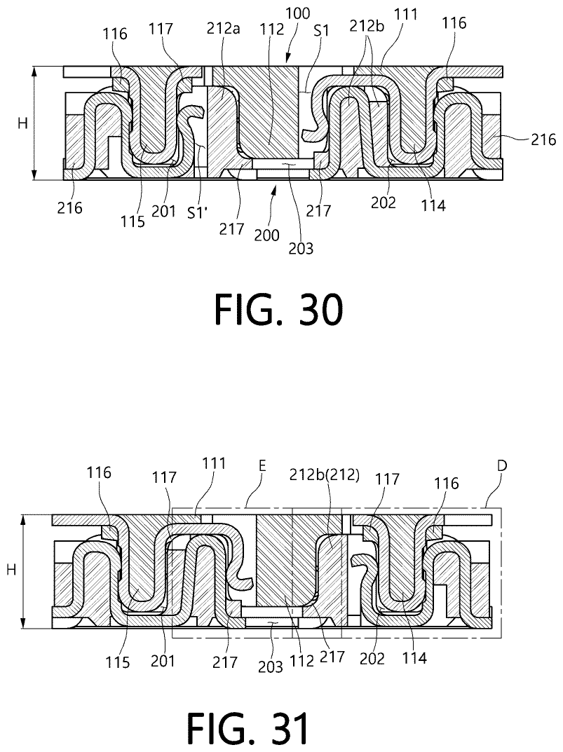

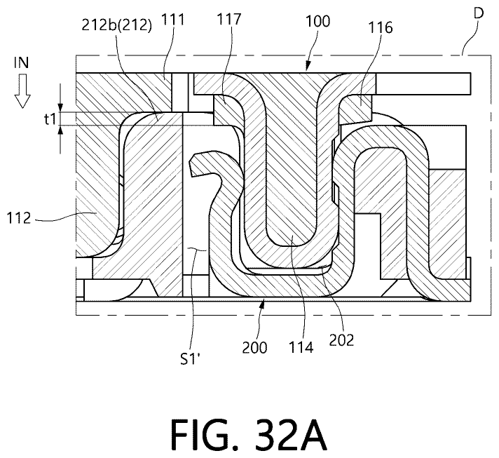

And when the first connector 100 and the second connector 200 are coupled with each other, the interior solder overflow preventer 117 of the first connector 100 may have a structure in which the step height t1 is accommodated in the displacement space S1′ of the second connector 200, and the exterior solder overflow preventer 217 of the second connector 200 may have a structure in which the step height t1′ is accommodated in the displacement space S1 of the first connector 100 (refer to FIGS. 32A and 32B).

Accordingly, the first connector 100 and the second connector 200 constituting the connector assembly 1 according to an embodiment of the present disclosure may further reduce the height (thickness) in the third direction while maintaining the insulator thickness of the important portion, thereby realizing a thinner plate and miniaturizing the entire product.

Meanwhile, in the connector assembly 1 according to an embodiment of the present disclosure, the plurality of in solder overflow preventers 117 and 217 formed to protrude from the first connector 100 and the second connector 200 in the third direction may have a continuous concavo-convex shape with directionality in the first direction together with the upper surface of the bottoms 111 and 211.

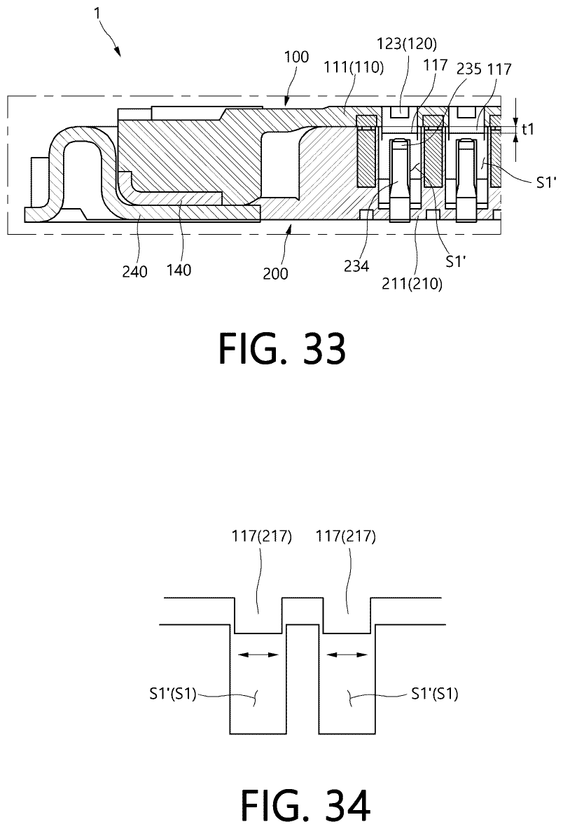

Since the plurality of interior solder overflow preventers 117 and 217 having such a concavo-convex shape are accommodated in a manner of interlocking like gear teeth in a plurality of displacement spaces S1′ and S1 of the counterpart connector, when an external force is generated, the pitch direction flow is prevented, so it is easy to maintain contact alignment, and it is of course possible to prevent contact from being twisted or detached even if the external force is generated (refer to FIG. 34).

Specifically, the first connector 100 constituting the connector assembly 1 according to an embodiment of the present disclosure may largely include a first connector insulator 110 and a first contact 120 and a second contact 130 for transmitting electrical signals.

In this case, the first connector insulator 110 may include a pair of holding walls 114 and 115 configured to protrude from the bottom 111 of a flat plate with a length and height, and an island 112 configured to protrude from the bottom 1112 with a length and height between the holding walls 114 and 115.

In this case, the first coupling space 101 and the second coupling space 102 may be formed between the island 112 and the holding walls 114 and 115, in which the interior holding walls 212a and 212b of the second connector 200 are accommodated.

The holding walls 114 and 115 may be divided into a first holding wall 114 and a second holding wall 115 with respect to a longitudinal virtual centerline C of the first connector 100.

And, the first contact 120 and the second contact 130 may have a structure in which they are arranged alternately spaced apart from each other along the first direction on each of the first holding wall 114 and the second holding wall 115 in a bar shape having a length in the second direction. In addition, the first contact 120 and the second contact 130 may be arranged to face each other on a line in the second direction. In other words, the first contact 120 disposed on the first holding wall 114 is arranged at a position facing the second contact 130 disposed on the second holding wall 115 (refer to FIG. 7B).

In the long direction (length direction), the first contact 120 and the second contact 130 are arranged alternately and cross-aligned, while in the short direction (width direction), the first contact 120 and the second contact 130 are arranged at a position facing each other.

Meanwhile, the second connector 200 may include a second connector insulator 210, and a first contact 220 and a second contact 230 for transmitting electrical signals.

In this case, the second connector insulator 210 includes a pair of exterior holding walls 214 and 215 configured to protrude from the bottom 211 of a flat plate with a length and height and a pair of interior holding walls 212a and 212b configured to protrude with a length and height between the exterior holding walls 214 and 215 while forming the island accommodating space 203 in which the island 112 of the first connector 100 is accommodated, and a first accommodating space 201 and a second accommodating space 202 in which the holding walls 114 and 115 of the first connector 100 are received between the interior holding walls 212a and 212b and the exterior holding walls 214 and 215.

The pair of exterior holding walls 214 and 215 and the pair of interior holding walls 212a and 212b are not illustrated, but based on the longitudinal virtual centerline C as in the first connector, the exterior holding walls 214 and 215 may be divided into the first exterior holding wall 214 and the second exterior holding wall 215, and the interior holding walls 212a and 212b may be divided into the first interior holding wall 212a and the second interior holding wall 212b.

And, the first contact 220 and the second contact 230 may have a structure in which they are configured to be alternately spaced apart from each other along the first direction on each of the exterior holding walls 214 and 215 and the interior holding walls 212a and 212b in a bar shape having a length in the second direction.

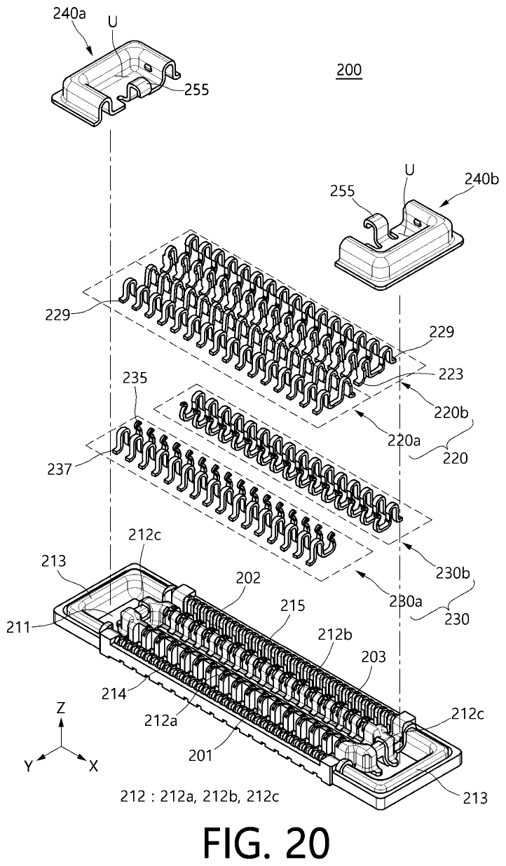

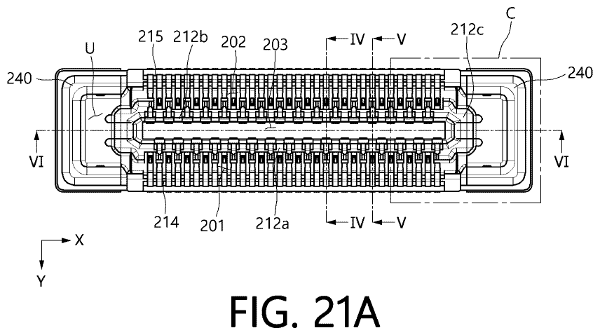

In other words, the first contact 220 and the second contact 230 may be alternately spaced apart from each other along the first direction on the first exterior holding wall 214 and the first interior holding wall 212a, which are located in the same second direction based on the longitudinal virtual centerline C according to shape characteristics thereof, and alternately spaced apart from each other along the first direction on the second exterior holding wall 215 and the second interior holding wall 212b. In addition, the first contact 120 and the second contact 130 may be arranged to face each other on a line in the second direction. In other words, the first contact 220 disposed on the first exterior holding wall 214 and the first interior holding wall 212a is arranged at a position facing the second contact 230 disposed on the second exterior holding wall 215 and the second interior holding wall 212b (refer to FIGS. 20 and 21B).

In the long direction (length direction), the first contact 220 and the second contact 230 are arranged alternately and cross-aligned, while in the short direction (width direction), the first contact 220 and the second contact 230 are arranged at a position facing each other.

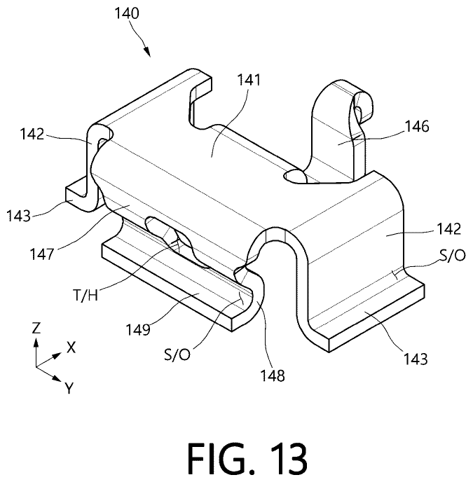

On the other hand, the first connector insulator 110 of the first connector 100 forms the interior solder overflow preventer 117 protruding to have a step height t1 from the bottom 111 on the upper portion of the first contact 120 disposed in the first coupling space 101 and the second coupling space 102 (refer to FIG. 15).

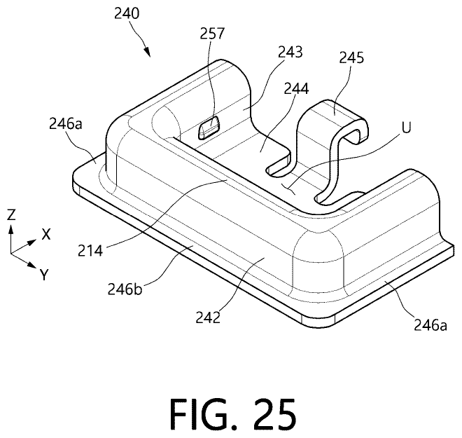

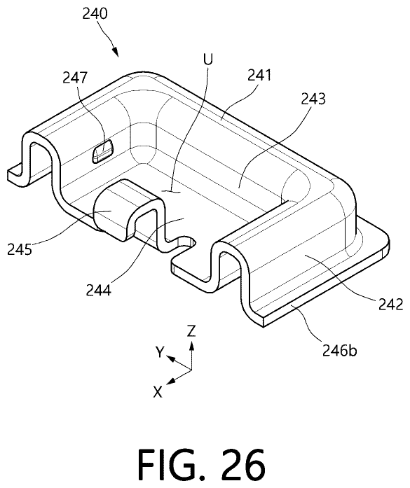

The second connector insulator 210 of the second connector 200 forms a groove or hole-shaped displacement space S1′ such that the second contact 230 disposed on the interior holding wall 212a or 212b is elastically deformable (refer to FIGS. 27 and 28).

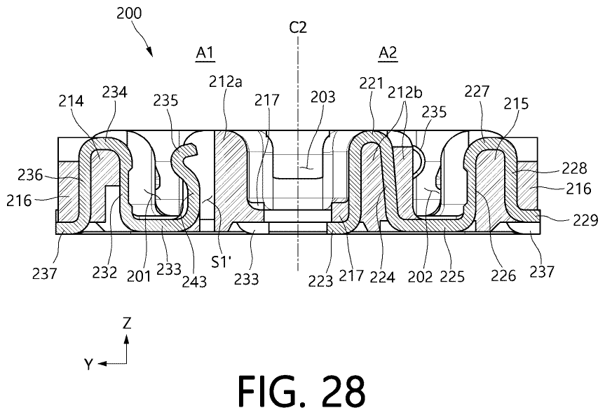

When the first connector 100 and the second connector 200 are coupled with each other to form the connector assembly 1, the interior solder overflow preventer 117 of the first connector 100 is accommodated in the displacement space S1′ of the second connector 200 to minimize the height (thickness) in the third direction (refer to FIGS. 30 to 32B).

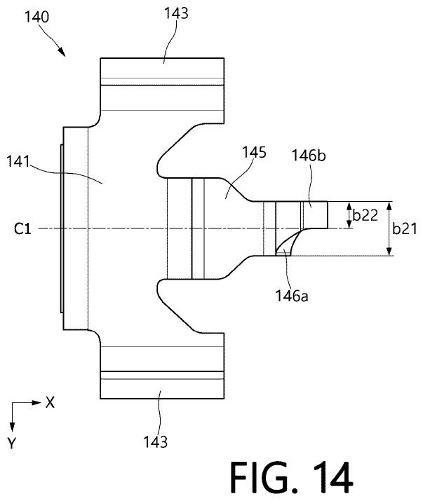

On the other hand, the first connector insulator 110 of the first connector 100 forms a groove or hole-shaped displacement space S1 such that the second contact 130 disposed on the island 112 is elastically deformable (refer to FIGS. 15 and 16).

In addition, the second connector insulator 210 of the second connector 200 forms an interior solder overflow preventer 217 protruding to have a step height t1′ from the bottom 211 on the upper portion of the first contact 220 disposed on the island accommodating space 203 (refer to FIGS. 27 and 28).

And, when the first connector 100 and the second connector 200 are coupled with each other to form the connector assembly 1, the interior solder overflow preventer 217 of the second connector 200 is accommodated in the displacement space S1 of the first connector 100 to minimize the height (thickness) in the third direction (refer to FIGS. 30 to 32B).

Meanwhile, the first connector 100 constituting the connector assembly 1 according to an embodiment of the present disclosure reduces the length of the long direction (length direction, first direction of the X-axis) to realize miniaturization.

Specifically, the first connector 100 may include a pair of first connector hold-downs 140: 140a and 140b.

At this time, the pair of first connector hold-downs 140: 140a and 140b have a structure that wraps around the pair of hold-down holding walls 113 that connect both ends of the first holding wall 114 and the second holding wall 115 in the first direction and wraps around an island end 112a of the island 112.

In this case, the first connector hold-downs 140 have a structure in which the end of an island end protecting section 146 wrapping around the island end 112a is arranged with gap d1, d2 or d3 spaced apart from the first contact 120 and the second contact 130 with respect to the longitudinal virtual centerline C1 of the first connector 100 and is biased to one side in the second direction (refer to FIG. 7B).

As described above, the first contact 120 and the second contact 130 are alternately arranged along the first direction. At this time, the first contact 120 and the second contact 130 are arranged to face each other on a line in the second direction. In this case, the first contact 120 has a fixed terminal shape in which the interior mounting section 123 is disposed on one side of the bottom 111. And, the second contact 130 is a movable terminal having an elastic contacting section 135, and the elastic contacting section 135 is elastically deformed in the displacement space S1 formed in the island 112.

Accordingly, the island 112 may have a structure in which a portion where the displacement space S1 is formed and a portion not formed are alternately arranged along the first direction.

As such, since the first contact 120 in the form of a fixed terminal and the second contact 130 in the form of a movable terminal have an alternating cross arrangement in which they are alternately spaced apart from each other, it may be easy to secure the strength of the first connector insulator 110.

If only the movable terminals are arranged, a groove or hole-shaped displacement space S1 has to be continuously formed adjacent to each other, and such a continuous displacement space S1 inevitably leads to a weakening of the strength of the connector insulator.

Meanwhile, as described above, the first connector hold-downs 140 have a structure in which the end of the island end protecting section 146 is arranged to be biased to one side in the second direction without being disposed along the longitudinal virtual centerline C1. In other words, the island end protecting section 146 may be arranged to be biased to a portion where the displacement space S1 of the island 112 is not formed for a stable arrangement while having a gap to prevent interference and short generation with the first contact 120 and the second contact 130 (refer to FIG. 7B).

In addition, the first connector hold-downs 140 may be divided into a first hold-down 140a disposed on one side in the first direction and a second hold-down 140b disposed on the other side in a position opposite to the first hold-down 140a in the first direction.

In this case, the island end protecting section 146 of the first hold-down 140a and the island end protecting section 146 of the second hold-down 140b have a structure in which they are arranged to be biased in different second directions with respect to the longitudinal virtual centerline C1 of the first connector 100 (refer to FIG. 7A).

In other words, the island end protecting section 146 of the first hold-down 140a and the island end protecting section 146 of the second hold-down 140b are arranged to be biased to a portion where the displacement space S1 of the island 112 is not formed while protecting the island at each position.

Accordingly, the island end protecting section 146, which constitutes the first connector hold-downs 140 made of a metal material, has a gap d1, d2 or d3 spaced apart from the first contact 120 and the second contact 130, and may be located inwardly in the longitudinal direction of the island 112 in the first direction (refer to FIG. 7A).

As a result, the length of the first connector 100 in the first direction may be further reduced, and the second connector 200 coupled to the first connector 100 may also be reduced to the size corresponding to the first connector 100, so that the length of the connector assembly 1 in the long direction (length direction, first direction of the X-axis) may be further reduced to realize miniaturization.

### —First Connector 100—

Hereinafter, the first connector 100 constituting the connector assembly 1 according to an embodiment of the present disclosure will be described in more detail with reference to FIGS. 5 to 18B and 35.

As described above, the first connector 100 according to the embodiment of the present disclosure may be configured to improve contact reliability while being miniaturized through a change in the structure of the first connector 100. In addition, it may be configured to minimize the increase in size of the product while including the hold-down 140 for strength reinforcement to implement miniaturization.

To this end, the first connector 100 according to an embodiment of the present disclosure may include a first connector insulator 110 mounted on a substrate and coupled with the substrate, a plurality of first contacts 120 and second contacts 130 coupled with the first connector insulator 110 and mounted on the substrate, and a first connector hold-down 140 for improving a reinforcing force.

The first connector insulator 110 is a non-conductive material and may be manufactured by insert molding including the first contact 120 and the second contact 230. In addition, it is also possible to first manufacture the first connector insulator 110 by injection molding or the like, and then assemble the first contact 120 and the second contact 130 to the first connector insulator 110 according to the implementation example. However, in the present disclosure, as an embodiment, it will be described on the premise that it was manufactured through insert molding, unless otherwise described.

The first connector insulator 110 may include a bottom 111, an island 112, a pair of hold-down holding walls 113, and a pair of holding walls 114 and 115.

First, the bottom 111 may have a flat plate shape having a length in the first direction and a width in the second direction.

In addition, the pair of holding walls 114 and 115 may have a shape configured to protrude from the bottom 111 in a third direction with a height and extend in parallel with each other in the first direction with a length.

In addition, island 112 may have a shape configured to protrude in a third direction from the bottom 111 with a height and extends between a pair of holding walls 114 and 115 with a length parallel to the holding walls 114 and 115.

In addition, a pair of hold-down holding walls 113 may have a shape configured to protrude in a third direction from the bottom 111 with a height to connect both ends of the first holding wall 114 and the second holding wall 115 in the first direction.

Meanwhile, referring to FIG. 7A, based on the longitudinal virtual centerline C1 of the first connector 100, the pair of holding walls 114 and 115 may be divided into the first holding wall 114 and the second holding wall 115 in the second direction, and the island 112 is a single block shape configured to protrude in the first direction with a height in the third direction, but may be divided into the left island 112-1 and the right island 112-2 in the second direction for ease of explanation.

Meanwhile, when the first connector 100 and the second connector 200 are coupled with each other, the island 112 of the first connector 100 may be coupled with the island accommodating space 203 formed between the interior holding walls 212a and 212b of the second connector 200, the first holding wall 114 of the first connector 100 may be coupled with the second accommodating space 202 formed between the second interior holding wall 212b and the second exterior holding wall 215 of the second connector 200, and the second holding wall 115 of the first connector 100 may be coupled with the first accommodating space 201 formed between the first interior holding wall 212a and the first exterior holding wall 214 of the second connector 200 (refer to FIG. 30).

The bottom 111 and the pair of holding walls 114 and 115 and the island 112 serves to hold the shape of the first connector 100 and stably arrange the contacts 120 and 130, and support the contacts so that contacts between the contacts may be maintained when the first connector 100 is coupled with the second connector 200, which is a counterpart connector, and may be formed to have a predetermined thickness, height, and width.

The first contact 120 may be configured as a plurality of pieces having a length in the second direction and having a bent bar shape with at least a portion exposed to the outside and spaced apart from each other along the first direction on each of the holding walls 114 and 115.

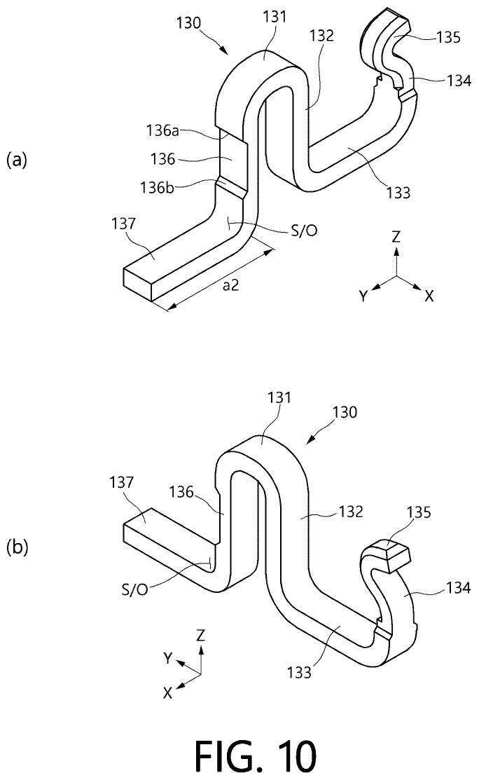

In this case, each of the first contacts 120 is configured to be supported while wrapping around the holding wall 114 or 115 and includes interior mounting section 123 bent along the bottom 111 toward the island 112 and be exposed to a lower surface of the bottom 111 and is mounted on a substrate while interior side forming an interior molding space S/I upward in the second direction upward (refer to FIGS. 6 and 9).

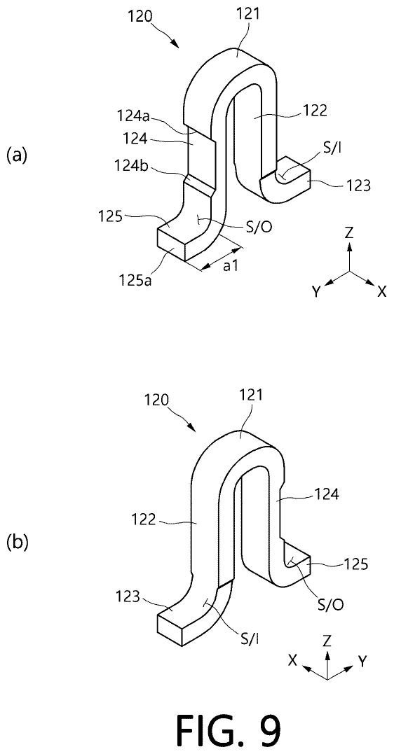

Preferably, the first connector insulator 110 may include an inspection window S2 formed to penetrate it to check the interior mounting section 123 of the first contact 120 from the outside. In this case, the inspection window S2 may be in plurality according to the number of the first contacts 120 (refer to FIGS. 7B and 8).

In addition, the first connector insulator 110 includes interior solder overflow preventer 117 configured in the interior molding space S/I formed while the first contact 120 is disposed to have a stepped height t1 protruding from an upper surface of the bottom 111 in a third direction.

In this case, the interior solder overflow preventer 117 may be formed in plurality to correspond to the plurality of first contacts 120 and may form a concavo-convex with the bottom 111 and directionality in the first direction.

On the other hand, the second contact 130 has a length in the second direction and is bent in a shape of a bar, at least a portion of which is exposed to the outside, and consists of a plurality of contacts arranged alternately spaced apart from the first contact 120 on each of the holding walls 114 and 115.

In this case, the second contact 130 is alternately arranged with the first contact 120 in the first direction, but may be disposed to face the first contact 120 in the second direction.

Next, the first connector insulator 110 may further include first connector hold-downs 140 mounted on the substrate and fixing the first connector insulator 110 to the substrate while wrapping around a pair of hold-down holding walls 113 connecting both ends of the pair of holding walls 114 and 115 in the first direction for strength reinforcement.

In this case, each of the first connector hold-downs 140 may include a bottom protecting section 145 wrapping around the bottom 111 by extending a portion wrapping around the hold-down holding wall 113 in a direction of an island end 112a on one of both sides of the island 112 in the first direction, and an island end protecting section 146 wrapping around the island end 112a by extending the bottom protecting section 145 upward in the third direction.

Preferably, the island end protecting section 146 has a structure configured to have gaps spaced apart from the first contact 120 and the second contact 130 and to be biased to one side in the second direction with respect to the longitudinal virtual centerline C1 and be biased to one side in the second direction.

As such, as the island end protecting section 146 is biased to one side in the second direction, the first connector 100 may further reduce the length in the long direction to realize miniaturization.

Meanwhile, referring to FIGS. 5 to 8 and 9, the first contact 120 provided in the first connector 100 will be described in more detail as follows.

As described above, the first contacts 120 may be alternately arranged with the second contacts 130 at an ultra-narrow pitch in one row on each of the first holding wall 114 and the second holding wall 115. In other words, the first contact 120 may be divided into a first row of a first contact line 120a disposed on the first holding wall 114 and a second row of a first contact line 120b disposed in the second holding wall 115.

The first contact 120 has a length in the second direction and has a bent bar shape.

The first contact 120 may be configured such that the interior mounting section 123 is positioned inwardly the first connector insulator 110.

Specifically, referring to FIG. 9, the first contact 120 of the first connector 100 may largely include a connecting section 121, an interior contacting section 122, an interior mounting section 123, an exterior contacting section 124, and a carrier connecting section 125.

First, the connecting section 121 may be partially exposed to the outside in a shape of a bar that warps around an upper portion of the holding walls 114 and 115 and is supported by it.

And, the interior contacting section 122 may be in a shape of an extended bar with an interior end of the connecting section 121 bent in the second direction and supported while wraping around an inner surface of the holding walls 114 and 115 and partially exposed to the outside.

In addition, the interior mounting section 123 may be in a shape of bar bent and extended while an end of the interior contacting section 122 forms the above-described interior molding space S/I, and the end thereof may be located on one side of the bottom 111. At this time, the end of the interior mounting section 123 has a structure exposed to a lower surface of the bottom 111, and an inspection window S2 may be formed through the bottom 111 so that the interior mounting section 123 may be visually inspected from the outside. The interior mounting section 123 may be visually checked from the outside through the above-described inspection window S2 (FIG. 8).

In addition, the exterior contacting section 122 may be in a shape of a bar with the exterior end of the connecting section 121 bent in the second direction and supported while wraping around an outer surface of the holding walls 114 and 115 and partially exposed to the outside.

At this time, the exterior contacting section 124 includes an upper jaw 124a and a lower jaw 124b protruding to the outside and through which, when mating with the second connector 200, which is the counterpart connector, the contact of the counterpart connector makes touch each other and generates a “click” sound, thereby facilitating a coupling process and preventing detachment, thereby increasing the coupling force.

The carrier connecting section 125 has a predetermined length a1 in a bar shape extended in the opposite direction to the interior mounting section 123 while an end of the exterior contacting section 124 forms the exterior molding space S/O upward, and the end thereof may be exposed to the outside of the first connector insulator 110.

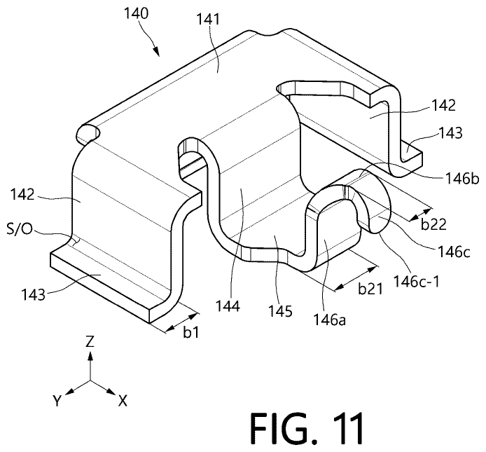

The carrier connecting section 125 is a portion that connects the carrier (not shown) used to fix the contacts in position during the manufacturing process of the connector and the first contact 120 and has a structure in which the end surface 125a is located close to the first connector insulator 110 and exposed according to the cutting during the process. The carrier connecting section 125 has a shorter length a1 (FIG. 9) than the length a2 (FIG. 10) of the exterior mounting section 137 of the neighboring second contact 130, to prevent interference and short circuit with the second contact 130.

Meanwhile, in the exterior molding space S/O formed by the carrier connecting section 125, the exterior solder overflow preventer 116 is provided so that the soldering soldered in the exterior mounting section 137 forming the neighboring second contact 130 does not burn and rise and cause a defect, and is continuously connected in a bar shape to fill the exterior molding space S/O described above, and the exterior solder overflow preventer 116 is continuously connected (FIGS. 15 and 16).

Meanwhile, referring to FIGS. 5 to 8 and 10, the second contact 130 provided in the first connector 100 will be described in more detail below.

As shown in FIG. 1, the second contact 130 has a length in the second direction and has a bent bar shape. The second contact 130 has a structure that is alternately arranged with the first contact 120 and wraps around the holding walls 114 and 115 and the bottom 111. In other words, the second contact 130 may be divided into a first row of second contact lines 130a disposed on the first holding wall 114 and a second row of first contact lines 130b disposed in the second holding wall 115.

Meanwhile, the second contact 130 is a movable terminal, and may have a structure including an elastic arm section 134 configured by a portion extending along the bottom 111 toward the island 112 being bent and extended upward in the third direction again, an elastic contacting section 135 configured by extending an end of the elastic arm section 134 and configured as a free end that is elastically operated by an external force, and an exterior mounting section 137 configured to be extended in the opposite direction to the elastic contacting section 135 so that an exterior portion in the second direction wrapping around the holding wall 114 or 115 protrudes outside the first connector insulator 110.

More specifically, referring to FIG. 10, the second contact 130 may largely include a connecting section 131, an interior holding section 132, a bottom holding section 133, an elastic arm section 134, an elastic contacting section 135, an exterior contacting section 136, and an exterior mounting section 137.

First, the connecting section 131 may be partially exposed to the outside in a shape of a bar that warps around an upper portion of the holding walls 114 and 115 and is supported by it, like the connecting section 121 of the first contact 120.

The interior contacting section 132 may be in a shape of an extended bar with the interior end of the connecting section 131 bent in the second direction and supported while wraping around the inner surface of the holding walls 114 and 115 and partially exposed to the outside.

The bottom holding section 133 may be in a shape of a bar in which an end of the interior holding section 132 is bent and extended toward the island 112 and supported while wrapping around the bottom 111 of the first connector insulator 110 and partially exposed to the outside.

Next, the elastic arm section 134 may be configured to be exposed to the displacement space S1 formed in the island 112 in a shape of a bar extending while the end of the bottom holding section 133 is bent upward in the third direction again (refer to FIG. 8).

In addition, the elastic contacting section 135 is a free end in which an end of the elastic arm section 134 is extended and elastically operated by an external force in a roundly bent shape. At this time, the elastic contacting section 135 is also configured so that it is exposed to the displacement space S1, and the end of the elastic contacting section 135 faces the island, and the contact of the counterpart connector may be contacted at the rounded portion.

According to the elastic deformation of the elastic arm section 134 and the elastic contacting section 135, the contact between the first connector 100 and the second connector 200 may be reliably performed and the coupling strength may be increased when the connectors are coupled.

Meanwhile, the island 112 of the first connector insulator 110 may be divided into a left island 112-1 left in the second direction and a right island 112-2 right in the second direction with respect to the longitudinal virtual centerline C1 of the first connector 100, and in this case, the above-described displacement space S1 may be formed in a zigzag manner on the left island 112-1 and the right island 112-2 according to the arrangement of the first contact 130. Accordingly, the width of the first connector 100 may be further reduced (refer to FIGS. 7A and 7B).

In addition, exterior contacting section 136 may be in a shape of a bar with the exterior end of the connecting section 131 bent in the second direction, and supported while wraping around an outer surface of the holding walls 114 and 115 and partially exposed to the outside.

At this time, the exterior contacting section 136 includes an upper jaw 136a and a lower jaw 136b protruding to the outside and through which, when mating with the second connector 200, which is the counterpart connector, the contact of the counterpart connector makes touch each other and generates a “click” sound, thereby facilitating a coupling process and preventing detachment, thereby increasing the coupling force.

The exterior mounting section 137 is in a shape of a bar in which the end of the exterior contacting section 136 is bent and extended in the opposite direction to the elastic contacting section 135 and has a length a2 (FIGS. 10 and 5) sufficient to allow the end thereof to be exposed to the outside of the first connector insulator 110.

In addition, the exterior mounting section 137 forms an exterior molding space S/O in an upper portion, and an exterior solder overflow preventer 116 is formed in the exterior molding space S/O (refer to FIGS. 15 and 16).

Meanwhile, referring to FIGS. 5 to 8 and 11 to 14, first connector hold-downs 140 provided in the first connector 100 will be described in more detail below.

As described above, the first connector hold-downs 140 may be divided into a first hold-down 140a and a second hold-down 140b, and may be mounted on the substrate while wrapping around a pair of hold-down holding walls 113 connecting both ends of the pair of holding walls 114 and 115 in the first direction

In this case, each of the first connector hold-downs 140 may include a bottom protecting section 145 wrapping around the bottom 111 by extending a portion wrapping around the hold-down holding wall 113 in a direction of an island end 112a on one of both sides of the island 112 in the first direction, and an island end protecting section 146 wrapping around the island end 112a by extending the bottom protecting section 145 upward in the third direction.

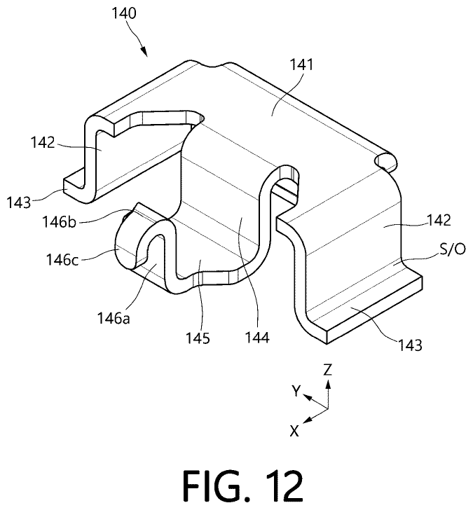

More specifically, referring to FIGS. 11 to 14, the first connector hold-down 140 may largely include an upper protecting section 141, a second direction protecting section 142, a second direction mounting section 143, an interior protecting section 144, a bottom protecting section 145, an island end protecting section 146, a first direction protecting section 147, a molding section 148, and a first direction mounting section 149.

First, as confirmed through FIGS. 5 and 6, the upper protecting section 141 may have a shape of a plate that wraps around and protects an upper portion of the hold-down holding wall 113 and have a predetermined width and depth, and a portion thereof may be exposed to the outside.

And, the second direction protecting section 142 may be in the plate shape formed by bending and extending both ends of the upper protecting section 141 in the second direction and wrap around the outer surface of the hold-down holding wall 113 in the second direction and a portion thereof may be exposed to the outside.

And, the second direction mounting section 143 may have a length b1 (FIG. 11) exposed to the outside of the first connector insulator 110 as a portion extended by bending both ends of the second direction protecting section 142, and may form an exterior molding space S/O upward. A solder overflow preventer may be formed in the exterior molding space S/O.

The interior protecting section 144 may have a shape of a plate in which the upper protecting section 141 is bent inward in the first direction and extends and wrap around the inner surface of the hold-down holding wall 113 in the first direction and partially exposed to the outside.

The bottom protecting section 145 may have a plate shape in which the interior protecting section 144 extends toward the island end 112a of both sides in the first direction of the island 112 to wrap around the bottom 111 and partially exposed to the outside.

Meanwhile, the island end protecting section 146 may have a predetermined width b21 corresponding to the width of the island end 112a as a portion in which the bottom protecting section 145 extends upward in the third direction and wraps around the island end 112a.

Meanwhile, more specifically, referring to FIG. 11, the island end protecting section 146 may include a side protecting plate 146a having a first width b21 and extending upward to wrap around an outer side of the island end 112a, and an upper surface protecting plate 146b configured to have a second width b22 narrower than the first width b21 at an upper end of the side protecting plate 146a in the third direction and extend to wrap around the upper side of the island end 112a.

At this time, the upper surface protecting plate 146b is configured to have gaps spaced apart from the first contact 120 and the second contact 130 and to be biased to one side in the second direction with respect to a longitudinal virtual centerline C1 of the first connector 100.

In other words, the upper surface protecting plate 146b may be biased toward the first contact 120 disposed on the first holding wall 114 with respect to the longitudinal virtual centerline C1 of the first connector 100 (refer to FIG. 7B).

Meanwhile, referring again to FIG. 11, the island end protecting section 146 may further include an extending plate 146c configured to be extended from the upper surface protecting plate 146b and bent downward.

In this case, the island ends 112a of the first connector insulator 110 further includes an escape groove 112a-1 in which the extending plate 146c described above is accommodated.

Accordingly, the end 146c-1 of the extending plate 146c is accommodated in the escape groove 112a-1, and the island end protecting section 146 of the first connector hold-down 140 may maintain a stable gap between the first contact 120 and the second contact 130 and prevent interference and shots from being generated from each other (refer to FIG. 7B).

Meanwhile, the upper surface protecting plate 146b of the first hold-down 140a and the upper surface protecting plate 146b of the second hold-down 140b may be biased to one side in different second directions with respect to the longitudinal virtual centerline C1 of the first connector 100 (refer to FIG. 7A).

On the other hand, the first direction protecting section 147 may be in the plate shape formed by bending and extending an end of the upper protecting section 141 in the first direction and wrap around the outer surface of the hold-down holding wall 113 in the first direction and a portion thereof may be exposed to the outside.

And, the molding section 148 is formed in a plate shape in which the first direction protecting section 147 is bent and extended, and is a portion that is molded integrally with the first connector insulator 110 during insert molding. At this time, the molding section 148 includes a through-hole T/H that penetrates, and the first connector hold-down 140 may be strongly combined with the first connector insulator 110 by being molded integrally with the resin layer that passes through the through-hole T/H during insert molding.

And, the first direction mounting section 149 may be exposed to the outside of the first connector insulator 110 as a portion extended by bending both ends of the molding portion 148.

In the first connector hold-down 140, the second direction mounting section 143 and the first direction mounting section 149 may be mounted on the first connector hold-down pattern 330 of the first connector PCB pattern 300 (FIG. 35) and fixed to the substrate, and may be used as a reinforcing force and a power terminal (a terminal for high current).

Referring to FIGS. 2, 3 and 35, the first connector 100 according to an embodiment of the present disclosure has a structure in which the first contact 120 and the second contact 130 are alternately arranged to be spaced apart along the first holding wall 114 and the second holding wall 115.

And the first contact 120 and the second contact 130 have arrangements facing each other on a line in the second direction.

In this case, the interior mounting section 123 of the first contact 120 may be configured such that it is exposed to the bottom 111 between the holding walls 114 and 115 and the island 112 to be checked through the inspection window S2.

And, the exterior mounting section 137 of the second contact 130 has a length and is exposed from the first connector insulator 110, and may be configured to be arranged and exposed on both sides in the second direction.

Accordingly, referring to FIG. 35, a PCB pattern 300 of the first connector may be arranged to be spaced apart from each other with a zigzag manner between a first contact PCB pattern 310 of the first connector connected to the interior mounting section 123 of the first contact 120 and a second contact PCB pattern 320 of the first connector connected to the exterior mounting section 137 of the second contact 130. Accordingly, it is possible to reduce short risk and soldering defects by preventing mutual interference.

### —Second Connector 200—

Hereinafter, the second connector 200 constituting the connector assembly 1 according to an embodiment of the present disclosure will be described in more detail with reference to FIGS. 19 to 29 and 36.

As described above, the second connector 200 according to the embodiment of the present disclosure may be configured to improve contact reliability while being miniaturized through a change in the structure of the second connector 200. In addition, it may be configured to prevent damage caused by external force through strength reinforcement.

To this end, the second connector 200 according to an embodiment of the present disclosure may include a second connector insulator 210 mounted on a substrate and coupled with the substrate, a plurality of first contacts 220 and second contacts 230 coupled with the second connector insulator 210 and mounted on the substrate, and a second connector hold-down 240 for improving a reinforcing force.

The second connector insulator 210 is a non-conductive material and may be manufactured by insert molding including the first contact 220 and the second contact 230. In addition, it is also possible to first manufacture the second connector insulator 210 by injection molding or the like, and then assemble the first contact 220 and the second contact 230 to the second connector insulator 210 according to the implementation example. However, in the present disclosure, as an embodiment, it will be described on the premise that it was manufactured through insert molding, unless otherwise described.

The second connector insulator 210 may include a bottom 211, a pair of interior holding walls 212: 212a and 212b and a pair of exterior holding walls 214 and 215. And, it may include a pair of hold-down holding walls 213.

First, the bottom 211 may have a flat plate shape having a length in the first direction and a width in the second direction.

In addition, the pair of exterior holding walls 214 and 215 may have a shape configured to protrude from the bottom 211 in a third direction with a height and extend in parallel with each other in the first direction with a length.

The pair of interior holding walls 212: 212a and 212b have a shape that protrudes from the bottom 211 in a third direction with a height and extends in parallel with the pair of exterior holding walls 214 and 215 between them.

In this case, the pair of interior holding walls 212: 212a and 212b define an island accommodating space 203 sized and shaped to accommodate the island 112 of the first connector 100 between them. The island accommodating space 203 may be in a shape of a hole or groove.

And, the pair of hold-down holding walls 213 and 220 have a shape that protrudes from the bottom 211 in a third direction with a height to connect both ends of the first exterior holding wall 214 and the second exterior holding wall 215 in the first direction.

Meanwhile, referring to FIG. 7A, based on the longitudinal virtual centerline C1 of the second connector 200, the pair of exterior holding walls 214 and 215 may be divided into a first exterior holding wall 214 and a second exterior holding wall 215 in the second direction. And, the interior holding wall 212 may be divided into a first interior holding wall 212a and a second interior holding wall 212b in the second direction to form the island accommodating space 203 between them.

Meanwhile, when the first connector 100 and the second connector 200 are coupled with each other, the island 112 of the first connector 100 may be coupled with the island accommodating space 203 formed between the interior holding walls 212a and 212b of the second connector 200, the first holding wall 114 of the first connector 100 may be coupled with the second accommodating space 202 formed between the second interior holding wall 212b and the second exterior holding wall 215 of the second connector 200, and the second holding wall 115 of the first connector 100 may be coupled with the first accommodating space 201 formed between the first interior holding wall 212a and the first exterior holding wall 214 of the second connector 200 (refer to FIG. 30).

The bottom 211 and the pair of exterior holding walls 214 and 215 and the pair of interior holding walls 212 serves to hold the shape of the second connector 200 and stably arrange the contacts 220 and 230, and support the contacts so that contacts between the contacts 220 and 230 may be maintained when the second connector 200 is coupled with the first connector 100, which is a counterpart connector, and may be formed to have a predetermined thickness, height, and width.

On the other hand, the first contact 220 may be configured as a plurality of pieces having a length in the second direction and having a bent bar shape with at least a portion thereof exposed to the outside and spaced apart from each other along the first direction on each of the plurality of exterior holding walls 214 and 215 and interior holding walls 212a and 212b.

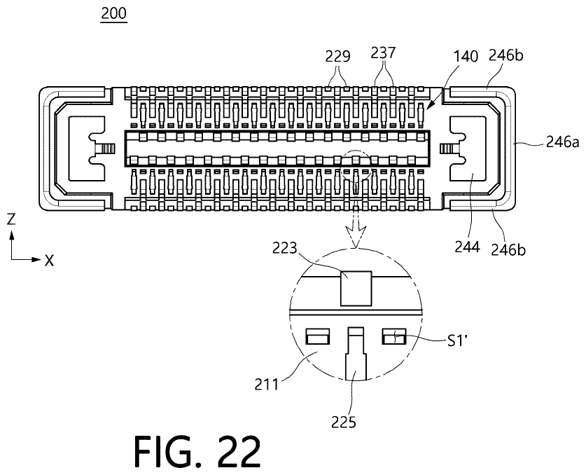

In this case, each of the first contacts 220 is configured to wrap around the exterior holding walls 214 and 215 and the bottom 211 and the interior holding walls 212a, 212b and supported while being partially exposed to the outside, and includes interior mounting section 223 bent toward the island accommodating space 203 and be exposed to a lower surface of the bottom 211 and is mounted on a substrate while the second direction inside wrapping around the interior holding walls 212a and 212b forming an interior molding space S/I (FIG. 23) upward (refer to FIGS. 21A and 21B).

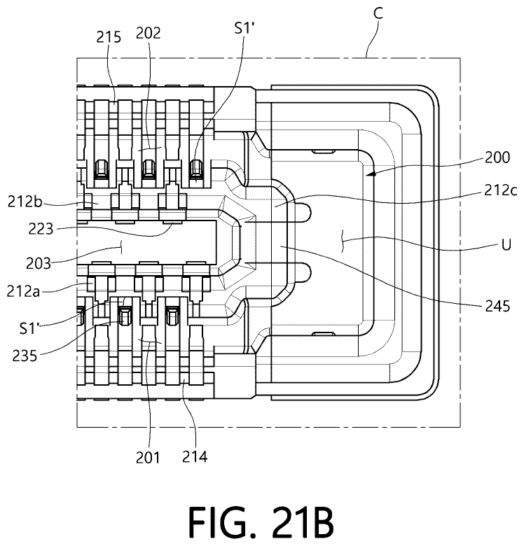

Preferably, the island accommodating space 203 may have a hole shape that penetrates the bottom 211 so that the interior mounting section 223 of the first contact 220 may be checked from the outside (refer to FIGS. 21A, 21B and 22).

Accordingly, the interior mounting section 223 of the first contact 220 is exposed to the island accommodating space 203 and may be visually checked from the outside, so it is possible to perform the soldering process while stably confirming the soldering.

And, the first connector insulator 210 includes interior solder overflow preventer 217 configured in the interior molding space S/I (FIG. 23) formed while the first contact 220 is disposed to have a stepped height t1′ (FIG. 32B) protruding from an upper surface of the bottom 211 in a third direction.

In this case, the interior solder overflow preventer 217 may be formed in plurality to correspond to the plurality of first contacts 220, and may form a concavo-convex with the bottom 211 and directionality in the first direction (refer to FIG. 29).

On the other hand, the second contact 230 has a length in the second direction and is bent in a shape of a bar, at least a portion of which is exposed to the outside, and consists of a plurality of alternatingly spaced apart from the first contact 220 in the first direction on each of the exterior holding walls 214 and 215 and on the interior holding walls 212a and 212b.

Next, the second connector insulator 210 may further include second connector hold-downs 240 mounted on the substrate and fixing the second connector insulator 210 to the substrate while wrapping around a pair of hold-down holding walls 213 connecting both ends of the pair of exterior holding walls 214 and 215 in the first direction.

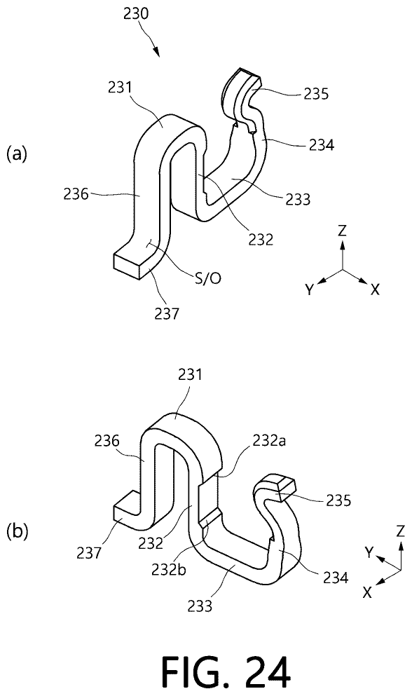

In this case, each of the second connector hold-downs 240 may include a bottom protecting section 244 wrapping around the bottom 211 by extending in the direction of both connecting walls 212c connecting the first interior holding wall 212a and the second interior holding wall 212b with a portion wrapping the hold-down holding wall 213, and a connection wall protecting section 245 wrapping around the connecting wall 212c by the bottom protecting section 244 extending upward in the third direction (refer to FIGS. 25 and 26)

And, the second connector hold-downs 240 may form a first hold-down accommodating groove U in which the first connector hold-down 140 is received when the first connector 100 and the second connector 200 are coupled with each other using an upper surface of the floor protecting section 244.

Meanwhile, referring to FIGS. 19 to 22 and 23, the first contact 220 provided in the second connector 200 will be described in more detail below.

As described above, the first contact 220 may be alternately arranged with the second contact 230 at an ultra-narrow pitch in one row on each of the exterior holding walls 214 and 215 and the interior holding walls 212a and 212b. In other words, the first contact 120 may be divided into a first row of a first contact line 220a disposed on the first exterior holding wall 214 and the first interior holding wall 212a and a second row of a second contact line 220b disposed on the second exterior holding wall 215 and the second interior holding wall 212b.

The first contact 220 may have a length in the second direction and have a bent bar shape.

The first contact 220 may be disposed such that the interior mounting section 223 is positioned in the island accommodating space 203 that is inwardly the first connector insulator 210 (refer to FIG. 21B).

Specifically, referring to FIG. 23, the first contact 220 of the second connector 200 may largely include an interior connecting section 221, an interior contacting section 222, an interior mounting section 223, an interior holding section 224, a bottom holding section 225, an exterior contacting section 226, an exterior connecting section 227, an exterior holding section 228, and a carrier connecting section 229.

First, the interior connecting section 221 may be partially exposed to the outside in a shape of a bar that warps around the upper portion of the interior holding walls 212a and 212b and is supported by it.

And, the interior contacting section 222 may be in a shape of an extended bar with the interior end of the interior connecting section 221 bent in the second direction and supported while wraping around an inner surface of the interior holding walls 212a and 212b and partially exposed to the outside. In this case, the interior contacting section 222 may have a wider width w1 than the other portions to facilitate contact with the contact of the counterpart connector.

In addition, the interior mounting section 223 may be in a shape of bar bent and extended while an end of the interior contacting section 222 forms the above-described interior molding space S/I, and the end thereof may be located on one side of the bottom 211. At this time, the end of the interior mounting section 223 has a structure exposed to a lower surface of the bottom 211 and may be visually checked through the island accommodating space 203.

And, the interior holding section 224 may be in a shape of an extended bar with the exterior end of the interior connecting section 221 bent in the second direction and supported while wraping around an outer surface of the interior holding walls 212a and 212b and partially exposed to the outside.

Meanwhile, the bottom holding section 225 may be the shape bar extending in the direction of the exterior holding walls 214 and 215 so that the interior holding section 224 wraps around the bottom 211, and a portion thereof may be exposed to the outside.

And, the exterior contacting section 226 may be in a shape of a bar having an end of the bottom holding section 225 extending upward and wrapped around an interior side of the exterior holding walls 214 and 215 in the second direction and partially exposed to the outside. In this case, the exterior contacting section 226 may include an upper jaw 226a and a lower jaw 226b protruding and may generate “click” sound when the exterior contacting section 226 is coupled with the counterpart connector through the upper jaw 226a and the lower jaw 226b, thereby facilitating a coupling process and preventing detachment, thereby increasing the coupling force.

The exterior connecting section 227 may be in a shape of a bar extending while the upper end of the exterior contacting section 226 wraps around an upper portion of the exterior holding walls 214 and 215 and partially exposed to the outside.

The exterior holding section 228 is in a shape of a bar in which the end of the exterior connecting section 227 is bent and extended, and may be partially exposed to the outside while wrapping around the exterior side of the exterior holding walls 214 and 215 in the second direction.

Next, the carrier connecting section 125 is in a shape of a bar bent while an end of the exterior holding section 228 forms the exterior molding space S/O and extended in the opposite direction to the interior mounting section 223, and partially exposed to the outside of the first connector insulator 210 (refer to FIG. 19).

The carrier connecting section 229 is a portion that connects the carrier (not shown) used to fix the contacts in position during the manufacturing process of the connector and the first contact 220 and has a structure in which the end surface 229a (FIG. 23) is located close to the second connector insulator 210 and exposed according to the cutting during the process. The carrier connecting section 229 is disposed to have a distance from the exterior mounting section 237 of neighboring the second contact 230, to prevent interference and short circuit with the second contact 230.

Meanwhile, in the exterior molding space S/O formed by the carrier connecting section 229, the exterior solder overflow preventer 216 is provided so that the soldering soldered in the exterior mounting section 237 forming the neighboring second contact 230 does not burn and rise and cause a defect, and is continuously connected in a bar shape to fill the exterior molding space S/O described above, and the exterior solder overflow preventer 216 is continuously connected (FIGS. 27 and 28).

Meanwhile, referring to FIGS. 19 to 22 and 24, the second contact 230 provided in the second connector 100 will be described in more detail below.

As described above, the second contacts 220 may be alternately arranged with the first contacts 130 at an ultra-narrow pitch in one row on each of the exterior holding walls 214 and 215 and the interior holding walls 212a and 212b. In other words, the second contact 220 may be divided into a first row of second contact lines 230a disposed on the first exterior holding wall 214 and the first interior holding wall 212a and a second row of second contact lines 230b disposed on the second exterior holding wall 215 and the second interior holding wall 112b.

Meanwhile, the second contact 230 is a movable terminal like the second contact 130 of the first connector, and may have a structure including an elastic arm section 234 configured by a portion extending along the bottom 211 toward the interior holding walls 212a and 212b being bent and extended upward in the third direction again, an elastic contacting section 235 configured by extending an end of the elastic arm section 234 and configured as a free end that is elastically operated by an external force, and an exterior mounting section 237 configured to be extended in the opposite direction to the elastic contacting section 235 so that an exterior portion in the second direction wrapping around the exterior holding wall 214 or 215 protrudes outside the second connector insulator 210.

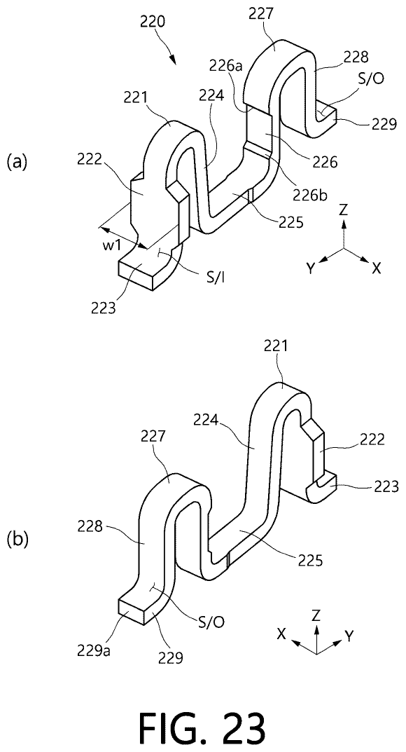

More specifically, referring to FIG. 24, the second contact 230 may largely include a connecting section 231, an exterior contacting section 232, a bottom holding section 233, an elastic arm section 234, an elastic contacting section 235, an exterior holding section 236, and an exterior mounting section 237.

First, the connecting section 231 may be partially exposed to the outside in a shape of a bar that warps around an upper portion of the exterior holding walls 214 and 215 and is supported by it, like the outer connecting section 227 of the first contact 220.

The exterior contacting section 232 may be in a shape of an extended bar with the exterior end of the connecting section 231 bent in the second direction and supported while wraping around the inner surface of the exterior holding walls 214 and 215 and partially exposed to the outside. In this case, the exterior contacting section 232 may include an upper jaw 232a and a lower jaw 232b protruding and may generate “click” sound when the exterior contacting section 232 is coupled with the counterpart connector through the upper jaw 232a and the lower jaw 232b, thereby facilitating a coupling process and preventing detachment, thereby increasing the coupling force.

The bottom holding section 233 may be in a shape of a bar in which an end of the exterior holding section 132 is bent and extended toward the interior holding walls 212a and 212b and supported while wrapping around the bottom 211 of the second connector insulator 210 and partially exposed to the outside.

Next, the elastic arm section 234 may be configured to be exposed to the displacement space S1′ formed in the interior holding walls 212a and 212b in a shape of a bar extending while the end of the bottom holding section 233 is bent upward in the third direction again (refer to FIGS. 21B, 27 and 28).

In addition, the elastic contacting section 235 is a free end in which an end of the elastic arm section 234 is extended and elastically operated by an external force in a roundly bent shape. At this time, the elastic contacting section 235 is also configured such that it is exposed to the displacement space S1′, and the end of the elastic contacting section 235 faces the interior holding walls 212a and 212b, and the contact of the counterpart connector may be contacted at the rounded portion.

According to the elastic deformation of the elastic arm section 234 and the elastic contacting section 235, the contact between the first connector 100 and the second connector 200 may be reliably performed and the coupling strength may be increased when the connectors are coupled.

And, the exterior holding section 224 may be in a shape of an extended bar with the exterior end of the connecting section 221 bent in the second direction and supported while wraping around an outer surface of the exterior holding walls 214 and 215 and partially exposed to the outside.

And, the exterior mounting section 237 is in a shape of a bar in which the end of the exterior holding section 136 is bent and extended in the opposite direction to the elastic contacting section 235 and the end thereof may be exposed to the outside of the second connector insulator 210 for mounting.

In addition, the exterior mounting section 237 forms an exterior molding space S/O (FIG. 24) in an upper portion, and an exterior solder overflow preventer 216 is formed in the exterior molding space S/O (refer to FIGS. 27 and 28).

Meanwhile, referring to FIGS. 19 to 22 and 25 and 26, the second connector hold-downs 240 provided in the second connector 200 will be described in more detail below.

When the first connector 100 and the second connector 200 are physically coupled with each other, the first connector hold-downs 140 and the second connector hold-downs 240 may reinforce the strength of the connectors 100 and 200 by preventing damage caused by physical contact between them with a metal material, and may also be used as a power terminal (a terminal for high current) when the first connector 100 and the second connector 200 are physically coupled with each other to form a connector assembly 1.

As described above, the second connector hold-downs 240 may be divided into a first hold-down 240a and a second hold-down 240b, and may be mounted on the substrate while wrapping around a pair of hold-down holding walls 113 connecting both ends of the pair of holding walls 114 and 115 in the first direction (refer to FIGS. 19 and 20).

And, each of the second connector hold-downs 240: 240a and 240b (FIG. 19) of the second connector 200 is disposed in a shape that wraps around the hold-down holding walls 213 (FIG. 20) on both sides in the first direction while simultaneously wrapping around the connecting wall 212c (FIG. 20) connecting the interior holding walls 212a and 212b and has an accommodating groove U so as to be able to accommodate the first connector hold-downs 140 described above, and may be mounted on the second connector hold-down pattern 430 of the second connector PCB pattern 400 (FIG. 36) and fixed to the substrate, and may be used as a reinforcing force and a power terminal (a terminal for high current).

As described above, each of the second connector hold-downs 240 may include a bottom protecting section 244 wrapping around the bottom 211 by extending in the direction of the connecting walls 212c with a portion wrapping the hold-down holding wall 213, and a connection wall protecting section 245 wrapping around the connecting wall 212c by the bottom protecting section 244 extending upward in the third.

More specifically, referring to FIGS. 25 and 26, each of the second connector hold-downs 240 may largely include an upper protecting section 241, an exterior protecting section 242, an interior protecting section 243, a bottom protecting section 244, and a connection wall protecting section 245.

First, the upper protecting section 241 may have a shape of a plate that wraps around and protects an upper portion of the hold-down holding wall 213 and have a predetermined width and depth, and a portion thereof may be exposed to the outside.

And, the exterior protecting section 242 may be in a shape of a plate in which an end of the upper protecting section 241 is bent and extends outward and wraps around the outer surfaces of the hold-down holding wall 213 in the first and second directions, and a portion thereof may be exposed to the outside.

And, the interior protecting section 243 may be a shape of a plate in which an end of the upper protecting section 241 is bent and extends inward to wraps around the inner surfaces of the hold-down holding wall 213 in the first and second directions, and a portion thereof may be exposed to the outside.

On the other hand, one side of the interior protecting section 243 may include a locking protrusion 247 protruding inward, and the locking protrusion 247 may push the first connector hold-down 140 when the first connector 100 and the second connector 200 are coupled with each other, thereby allowing the first connector hold-down 140 to be more strongly coupled and increasing contact and coupling force.

And, the bottom protecting section 244 may have a plate shape in which an end of the interior protecting section 243 described above extends in the direction of the connection wall 212c to wrap around the bottom 211.

In addition, the connection wall protecting section 245 may have a plate shape in which a portion of the bottom protecting section 244 extends upward in the third direction and wraps around the connection wall 212c.

On the other hand, an end of the exterior protecting section 242 may extend laterally to form a second direction mounting section 246a and a first direction mounting section 246b.

The first direction mounting section 246b and the second direction mounting section 246a are mounted on the second connector hold-down pattern 430 of the second connector PCB pattern 400 (FIG. 36) to be fixed to the substrate and increase the coupling force.

—A Connector Assembly 1 in which the First Connector 100 and the Second Connector 200 are Coupled with Each Other—

As described above, the connector assembly 1 according to an embodiment of the present disclosure may include a first connector 100 as a plug connector and a second connector 200 as a receptacle connector that are physically fastened to each other.

At this time, the connector assembly 1 according to an embodiment of the present disclosure enables miniaturization through the change in the structure of the first connector 100 and the second connector 200 and improves manufacturing convenience and contact reliability.

In addition, the connector assembly 1 according to an embodiment of the present disclosure makes it possible to maintain the insulator thickness (height) of the important portion while achieving miniaturization to prevent solder overflow and maintain contact fixation.

In addition, the connector assembly 1 according to an embodiment of the present disclosure includes hold-downs 140 and 240 for strength reinforcement while minimizing the size of the product and implementing miniaturization.

=To this end, the connector assembly 1 according to an embodiment of the present disclosure may have a length L1 in the first direction (FIG. 2) and a width L2 in the second direction (FIG. 2) and a thickness (height) H (FIG. 1) in the third direction by coupling the first connector 100 and the second connector 200.

In this case, the first connector 100 may be mounted on any one module substrate (not shown) through the first connector PCB pattern 300 (FIG. 35), and the second connector 200 may be mounted on another module substrate (not shown) through the second connector PCB pattern 400 (FIG. 36).

When the first connector 100 and the second connector 200 are physically coupled with each other to form the connector assembly 1, the first contact 120 and the second contact 130 provided in the first connector 100 are connected to the first contact 220 and the second contact 230 provided in the second connector 200 while being in contact with each other, and accordingly, the module substrate on which the first connector 100 is mounted and the module substrate on which the second connector 200 is mounted may be electrically connected to each other.

In addition, the first connector 100 and the second connector 200 may include first connector hold-downs 140: 140a and 140b and second connector hold-downs 240: 240a and 240b, respectively, to enable strength reinforcement and high current transmission.

When the first connector 100 and the second connector 200 are physically coupled with each other, the first connector hold-downs 140 and the second connector hold-downs 240 may reinforce the strength of the connectors 100 and 200 by preventing damage caused by physical contact between them with a metal material, and may also be used as a power terminal (a terminal for high current) when the first connector 100 and the second connector 200 are physically coupled with each other to form a connector assembly 1.

The connector assembly 1 according to an embodiment of the present disclosure may be implemented in a zigzag manner as the first contacts 120 and 220 and the second contacts 220 and 230 having different shapes are alternately arranged in the length of the first direction of the connectors 100 and 200, and thus the gap between the contacts 120 and 130 and 220 and 230 may be minimized (ultra-narrow pitch), so that the connector assembly 1 may be reduced in the length of the long direction (first direction of the X-axis) to be small.

The connector assembly 1 according to the present disclosure may be smaller because the displacement space S1 of the first connector 100 is arranged in a zigzag manner along the first direction, and thus the width of the connector 100 in the short direction (second direction of the Y-axis) may be reduced, and thus the size of the second connector 200 coupled to the first connector 100 may also be reduced, and thus the size of the second connector 200 may be reduced to be miniaturized.

In addition, the elastic contacting sections 135 and 235 of the contact may have a structure having elastic deformation in the displacement spaces S1 and S1′, and thus the fracture or detachment of the position due to the external force during the coupling process of the first connector 100 and the second connector 200 may be prevented, thereby leading to a more stable coupling.

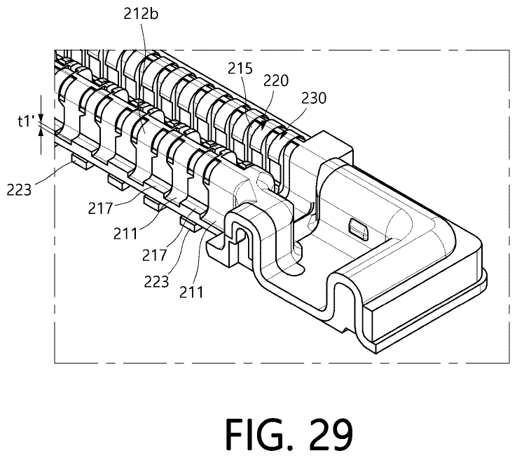

In addition, the interior solder overflow preventer 117 of the first connector 100 may have a step height t1 accommodated in the displacement space S1′ of the second connector 200 (refer to FIG. 32A), and the interior solder overflow preventer 217 of the second connector 200 may have a step height t1′ accommodated in the displacement space S1 of the first connector 100 (refer to FIG. 32B), thereby reducing the height in the third direction (thickness) H (FIG. 31), thereby realizing a thinner thickness and smaller size of the entire product.

In addition, since the plurality of interior solder overflow preventers 117 and 217 having such a concavo-convex shape are accommodated in a manner of interlocking like gear teeth in a plurality of displacement spaces S1′ and S1 of the counterpart connector, when an external force is generated, the pitch direction flow is prevented, so it is easy to maintain contact alignment, and it is of course possible to prevent contact from being twisted or detached even if the external force is generated (refer to FIG. 34).

In addition, the first connector hold-down 140 and the second connector hold-down 240 may be provided to protect both sides of the insulators 110 and 210, and thus the physical stability and contact stability may be increased while having strong rigidity against an external force when the connector assembly 1 is coupled.

In addition, since the island protecting section 146 of the first connector hold-down 140 may be biased to one side in the second direction based on the longitudinal virtual centerline C1 while protecting the island end 112a, the length of the first connector 100 may be further reduced, and the second connector 200, which is the counterpart connector, may also be reduced to a corresponding size, so that the length of the entire connector assembly 1 in the long direction (longitudinal direction, first direction of the X-axis) may be further reduced, thereby realizing miniaturization.

The present disclosure has been described with respect to the embodiments of the present disclosure, but the spirit of the present disclosure is not limited by the embodiments presented in the present specification, and those skilled in the art who understand the spirit of the present disclosure may easily propose other embodiments within the same spirit range, by adding, modifying, deleting, replacing, etc. components, within the scope of the present disclosure.

### LIST OF REFERENCE SIGNS

1: connector assembly
100: first connector
101: first coupling space
102: second coupling space
110: first connector insulator
111: bottom
112: island
112a: island end
112a-1: escape groove
113: hold-down holding wall
114: first holding wall
115: second holding wall
116: exterior solder overflow preventer
117: interior solder overflow preventer
120: first contact
121, 131: connecting section
122: interior contacting section
123: interior mounting section
124, 136: exterior contacting section
124a, 136a: upper jaw
124b, 136b: lower jaw
125: carrier connecting section
125a: end surface
130: second contact
132: interior holding section
133: bottom holding section
134: elastic arm section
135: elastic contacting section
137: exterior mounting section
140: first connector hold-down
140a: first hold-down
140b: second hold-down
141: upper protecting section
142: second direction protecting section
143: second direction mounting section
144: interior protecting section
145: bottom protecting section
146: island end protecting section
146a side protecting plate
146b: upper surface protecting plate
146c: extending plate
147: first direction protecting section
148: molding section
149: first direction mounting section
200: second connector
201: first accommodating space
202: second accommodating space
203: island accommodating space
210: second connector insulator
211: bottom
212: interior holding wall
212a: first interior holding wall
212b: second interior holding wall
212c: connecting wall
213: hold-down holding wall
214 first exterior holding wall
215: second exterior holding wall
216: exterior solder overflow preventer
217: interior solder overflow preventer
220: first contact
221: interior connecting section
222: Interior contacting section
223: Interior mounting section
224: Interior holding section
225, 233: bottom holding section
226, 232: exterior contacting section
226a, 232a: upper jaw
226b, 232b: lower jaw
227: exterior connecting section
228, 236: exterior holding section
229: carrier connecting section
229a: end surface
230: second contact
231: connecting section
234: elastic arm section
235: elastic contacting section
237: exterior mounting section
240: second connector hold-down
241: upper protecting section
242: exterior protecting section
243: interior protecting section
244: bottom protecting section
245: connection wall protecting section
246a: first direction mounting section
246b: second direction mounting section
U: accommodating groove
t1, t1′: the height of a step difference between interior solder overflow
preventer and bottom
S/P: exterior molding space.
S/I: interior molding space.
C: longitudinal virtual centerline
S1, S1′: displacement space
S2: inspection window

What is claimed is:

1. A first connector coupled with a second connector to form a connector assembly, comprising:
a first connector insulator including:
a bottom of a flat plate shape,
a pair of holding walls configured to protrude from the bottom and extend in parallel to each other along a first direction, and
an island configured to protrude from the bottom and extend in parallel between one of the pair of holding walls;
a plurality of first contacts configured to be at least partially exposed to outside the first connector insulator and be spaced apart from each other along the first direction on each of the holding walls; and
a plurality of second contacts configured to be at least partially exposed to the outside and be spaced apart alternately from the first contacts on each of the holding walls,
wherein each of the first contacts is configured such that it is a shape of a bent bar having a length in a second direction and supported while wrapping around one of the pair of holding walls, and includes an interior mounting section configured to be bent along the bottom toward the island and be exposed to a lower surface of the bottom and is mounted on a substrate while an interior side forming an interior molding space S/I upward in the second direction,
wherein the first connector insulator includes a solder overflow preventer configured to be stepped portion with height t1, protruding from an upper surface of the bottom in the interior molding space S/I in a third direction.

2. The first connector of claim 1, wherein the first connector insulator includes a plurality of inspection windows S2 configured to penetrate through the first connector insulator to allow the interior mounting section of the first contact from the outside.

3. The first connector of claim 1, wherein each of the first contacts includes:
a connecting section configured to wrap around an upper portion of one of the pair of holding walls;
an interior contacting section configured by the interior end of the connecting section in the second direction being bent and extended while wrapping around the interior surface of one of the pair of holding walls;
an interior mounting section configured by an end of the interior contacting section being bent and extended while forming the interior molding space S/I;
an exterior contacting section configured by an exterior end of the connecting section in the second direction being bent and extended while wrapping around an exterior surface of one of the pair of holding walls; and
a carrier connecting section configured by an end of the exterior contacting section forming an exterior molding space S/O upward and extending in an opposite direction to the interior mounting section.

4. The first connector of claim 1, wherein each of the second contacts is configured such that it is a shape of a bent bar having a length in the second direction and wraps around the holding wall or and the bottom, and includes:
an elastic arm section configured by a portion extending along the bottom toward the island being bent and extended upward in the third direction again;
an elastic contacting section configured as a free end in which an end of the elastic arm section is extended and elastically operated by an external force; and
an exterior mounting section configured to extend in an opposite direction to the elastic contacting section so that an exterior portion in the second direction wrapping around one of the pair of holding walls protrudes outside the first connector insulator.

5. The first connector of claim 4, wherein the island further includes displacement spaces S1 in the shape of a groove or hole to allow the elastic contacting section to be elastically deformed.

6. The first connector of claim 5, wherein the island is configured to be divided into a left island and a right island in the second direction with respect to a longitudinal virtual centerline C1, and
the displacement spaces S1 are configured on the left island and the right island to have a zigzag arrangement in the first direction.

7. The first connector of claim 1, wherein the first connector insulator further includes:
a pair of first connector hold-downs configured to be mounted on the substrate while wrapping around a pair of hold-down holding walls connecting both ends of the pair of holding walls in the first direction to fix the first connector insulator to the substrate, and
wherein each of the first connector hold-downs includes:
a bottom protecting section wrapping around the bottom by extending a portion wrapping around the hold-down holding wall toward an island end on one of both sides of the island in the first direction; and
an island end protecting section configured to wrap around the island end by extending the bottom protecting section upward in the third direction.

8. The first connector of claim 7, wherein the island end protecting section includes:
a side protecting plate configured to have a first width b21 predetermined and extending upward to wrap around an outer side of the island end,
an upper surface protecting plate configured to have a second width b22 narrower than the first width b21 at an upper end of the side protecting plate in the third direction and extend to wrap around an upper side of the island end,
wherein the upper surface protecting plate is configured to have gaps spaced apart from the first contact and the second contact and to be biased to one side in the second direction with respect to a longitudinal virtual centerline C1.

9. The first connector of claim 8, wherein the holding walls are configured to be divided into a first holding wall and a second holding wall with respect to the longitudinal virtual centerline C1, and
the upper surface protecting plate is configured to be biased to the first contact disposed on the first holding wall with respect to the longitudinal virtual centerline C1.

10. The first connector of claim 8, wherein the island end protecting section further includes an extending plate configured to extend from the upper surface protecting plate and bent downward,
wherein the island end further includes an escape groove in which the extending plate is accommodated.

11. The first connector of claim 8, wherein the first connector hold-down is configured to be divided into a first hold-down disposed on one side in the first direction and a second hold-down disposed on the other side in a position opposite to the first hold-down in the first direction,
the upper surface protecting plate of the first hold-down and the upper surface protecting plate of the second hold-down are configured to be biased to the second directions different from with respect to the longitudinal virtual centerline C1.

12. A second connector coupled with a first connector to form a connector assembly, comprising:
a second connector insulator including:
a bottom of a flat plate shape,
a pair of exterior holding walls configured to protrude from the bottom and extend in parallel to each other along a first direction, and
a pair of interior holding walls configured to protrude from the bottom and extend in parallel to each other between the pair of exterior holding walls to form an island accommodating space;
a plurality of first contacts configured to be at least partially exposed to outside the second connector insulator and be spaced apart from each other along the first direction on each of the exterior holding walls and the interior holding walls; and
a plurality of second contacts configured to be at least partially exposed to the outside and be spaced apart alternately from the first contacts on each of the exterior holding walls and the interior holding walls,
wherein each of the first contacts is configured such that it is a shape of a bent bar having a length in a second direction and supported while wrapping around the one of the exterior holding walls, the bottom, and one of the interior holding walls, and includes an interior mounting section configured to be bent toward the island accommodating space and be exposed to a lower surface of the bottom and is mounted on a substrate while an interior side wrapping around one of the interior holding walls forming an interior molding space S/I upward in the second direction,
wherein the second connector insulator includes an interior solder overflow preventer configured such that it has a stepped height t1′ protruding from an upper surface of the bottom in the interior molding space S/I in a third direction.

13. The second connector of claim 12, wherein the island accommodating space is configured in the shape of a hole penetrating the bottom to check the interior mounting section of the first contact from the outside.

14. The second connector of claim 12, wherein each of the first contacts includes:
an interior connecting section configured to wrap around an upper portion of one of the interior holding walls;
an interior contacting section configured by the interior connecting section extending while wrapping around an interior surface of one of the interior holding walls in the second direction;
an interior mounting section configured by extending an end of the interior contacting section;
an interior holding section configured by the interior connecting section extending while wrapping around an exterior surface of one of the interior holding walls in the second direction;
a bottom holding section configured by the interior holding section extending while wrapping around the bottom;
an exterior contacting section configured by the bottom holding section extending while wrapping around an interior side of one of the exterior holding walls in the second direction;
an exterior connecting section configured by the exterior contacting section extending while wrapping around an upper portion of one of the exterior holding walls;
an exterior holding section configured by the exterior connecting section extending while wrapping around an exterior side of one of the exterior holding walls in the second direction; and
a carrier connecting section configured by the exterior holding section being bent to form an exterior molding space S/O upward and extending in an opposite direction to the interior mounting section.

15. The second connector of claim 12, wherein each of the second contacts is configured such that it is a shape of a bent having a length in the second direction and supported while wrapping around one of the exterior holding walls and the bottom, and includes;
an elastic arm section configured by a portion extending along the bottom toward one of the interior holding walls being bent and extended upward in the third direction again;
an elastic contacting section configured as a free end in which an end of the elastic arm section is extended and elastically operated by an external force; and
an exterior mounting section configured to extend in an opposite direction to the elastic contacting section so that an exterior portion in the second direction wrapping around one of the exterior holding walls is exposed on a lower surface of the second connector insulator.

16. The first connector of claim 15, wherein one of the interior holding walls further includes displacement spaces S1′ in the shape of a groove or hole to allow the elastic contacting section to be elastically deformed.

17. A connector assembly in which a first connector and a second connector are coupled with each other and have a length in a first direction, a width in a second direction, and a thickness (height) in a third direction,
wherein the first connector comprises:
a first connector insulator including:
a pair of holding walls configured to protrude from a bottom of a flat plate and have a length and height,
an island configured to protrude from the bottom and have a length and a height between the holding walls, and
a first coupling space and a second coupling space in which interior holding walls of the second connector is accommodated between the island and the holding walls; and
a first contact and a second contact configured to be alternately spaced apart from each other along the first direction on each of the holding walls in a bar shape having a length in the second direction, and
wherein the second connector comprises
a second connector insulator including:
a pair of exterior holding walls configured to protrude from a bottom of a flat plate and have a length and height,
a pair of interior holding walls configured to protrude with a length and a height between the exterior holding walls while forming an island accommodating space in which the island of the first connector is received, and
a first accommodating space and a second accommodating space in which the holding walls of the first connector are received between the interior holding walls and the exterior holding walls, and
a first contact and a second contact configured to be alternately spaced apart from each other along the first direction on each of the exterior holding walls, and interior holding walls in a bar shape having a length in the second direction, and
wherein the first connector insulator is configured to have an interior solder overflow preventer configured to protrude with a step height t1 from the bottom on an upper portion of the first contact disposed in the first coupling space and the second coupling space, and
the second connector insulator is configured to have a groove or hole-shaped displacement space S1′ in which the second contact disposed on one of the interior holding walls is elastically deformable, and
when the first connector and the second connector are coupled with each other, the interior solder overflow preventer of the first connector is accommodated within the displacement space S1′ of the second connector.

18. The connector assembly of claim 17, wherein the first connector insulator configured to have a groove or hole-shaped displacement space S1 in which the second contact disposed on the island side is elastically deformable, and
the second connector insulator configured to have an interior solder overflow preventer configured to protrude with a stepped height t1′ from the bottom on an upper portion of the first contact disposed in the island accommodating space, and
when the first connector and the second connector are coupled with other, the interior solder overflow preventer of the second connector is accommodated within the displacement space S1 of the first connector.

19. The connector assembly of claim 17, wherein the first connector further includes:
a pair of first connector hold-downs configured to wrap around island ends of the island while wrapping around a pair of hold-down holding walls connecting both ends of the holding walls in the first direction and
wherein each of the first connector hold-downs is configured such that an end of an island end protecting section wrapping around the island end has gaps spaced apart from the first contact and the second contact and is biased to one side in the second direction with respect to a longitudinal virtual centerline C1 of the first connect.

20. The connector assembly of claim 19, wherein the first connector hold-down is configured to be divided into a first hold-down disposed on one side in the first direction and a second hold-down disposed on the other side in a position opposite to the first hold-down in the first direction, and
the island end protecting section of the first hold-down and the island end protecting section of the second hold-down are configured to be biased to the second directions different from with respect to the longitudinal virtual centerline C1 of the first connector.
